(19) United States
(12) Patent Application Publication
(10) Pub. No.: US 2002/0082881 A1
(43) Pub. Date: Jun. 27, 2002

(54) System providing event pricing for on-line exchanges

(76) Inventors: Marc Steven Price, Fairfax, VA (US); Reginald Candler Foster, McLean, VA (US)

Correspondence Address: STAAS & HALSEY LLP, 700 11TH STREET, NW, SUITE 500, WASHINGTON, DC, 20001, US

(21) Appl. No.: 09/741,908

(22) Filed: Dec. 22, 2000

Related U.S. Application Data
(60) Provisional application No. 60/241,799, filed on Oct. 20, 2000.

(51) Int. Cl. G06F 17/60

(52) U.S. Cl. 705/7; 705/26; 705/37; 705/80

(57) ABSTRACT

The present invention is a system that provides complex pricing for plural electronic exchange transaction events such that individual events, accumulated events, cross product events and non-transactional events can be priced. The system dynamically prices the electronic exchange events responsive to an electronic exchange event, ruled based pricing plan that includes a decision network with conditionally executed pricing algorithms. The pricing includes detail pricing and summary pricing. The algorithms include of single unit, double unit, taper discount, tier charge, tier discount, percent, flat, allowance, minimum, maximum, accumulation, threshold, multi-unit and taper charges.

### BACKGROUND OF THE INVENTION

1. Field of the Invention

The present invention is directed to a system that prices events in entities such as electronic exchanges, application services providers (ASPs) and portals and, more particularly, to a system that allows complex dynamic pricing of such events using rule based event pricing plans.

2. Description of the Related Art

Business-to-business (B2B) e-commerce enables greater efficiencies in markets and in the flow of commerce. Morgan Stanley Dean Witter reports “the Internet has finally arrived for the business-to-business market. The infrastructure has been built, companies are interested, and the economic environment is robust.” Industry analysts believe that on-line portals, ASPs and electronic exchanges, also called e-marketplaces, will succeed in many vertical and horizontal markets, enabling suppliers and buyers to find each other in new ways. To survive, portals, ASPs and exchanges must generate positive operating cash flow, which requires a business model with sustainable revenue. While different revenue models are emerging, most are reliant in some way upon the volume of transactions carried by the entities.

Emerging entities generally recognize a substantial portion of their revenue from transaction fees, both for baseline services as well as for ancillary, value-add services. This is revenue obtained from the buyer, seller or both for each transaction. The fee is typically: 1. A percentage of the transaction amount, which is popular where buyers and sellers do not have pre-negotiated pricing agreements, or 2. A fixed transaction fee, which is often used when buyers and sellers have pre-negotiated arrangements (e.g., pricing agreements or volume discounts) (see FIG. 4).

Other sources of revenue include referral fees, subscription fees, and advertising.

Initial attention in implementing electronic entities has focused on basic issues of functionality, ease-of-use, search engine capabilities, etc. Issues such as order fulfillment and price competitiveness are anticipated as these markets mature. In fact, steep competition among over 1000 emerging exchanges, ASPs and portals will likely make price a major differentiator.

Competitive price differentiation will likely be a strong driver for new software in this field. In particular, the capability to dynamically price electronic transactions with a high degree of sophistication will be highly attractive to the leading exchanges.

TAPESTRY, available from American Management Systems, Inc. (AMS) provides a solution for dynamic rules-based pricing of telephony events. Buysense.com, also available from AMS enables exchanges to feature pricing models that transcend simple flat fees and percentage of transaction fees. For example, Buysense.com offers customer-specific catalog pricing, and provides some rudimentary mechanisms for discounting. Much more robust features are needed in a ruthless, price competitive B2B exchange shake-out. More precisely, what is needed the ability to flexibly define rules enabling tapered and tiered charge structures, minimum and maximum charge definitions, and rules tailored specifically for suppliers' and buyers' unique customer structures.

### SUMMARY OF THE INVENTION

It is an aspect of the present invention to allow complex pricing of revenue producing transaction events for electronic marketplaces, ASPs and portals.

It is another aspect of the present invention to provide a system for pricing events that does not require recoding of software to alter complex price plans.

It is a further aspect of the present invention to use decision trees including structured pricing rules to price complex events.

It is a further aspect of the present invention to provide a system to provide pricing and discounting among affiliated customers.

It is yet another aspect of the present invention to manage the apportionment of transaction revenues between marketplaces when the transaction is handed from one marketplace to another for completion.

It is an aspect of the present invention to provide all of the pricing and discounting functionality using an architecture that permits the scaling to very large transaction volumes.

It is an additional aspect of the present invention to provide a system which allows flexible tailoring of calculations for specific pricing instances.

It is also an aspect of the present invention to provide a system that allows one calculation to affect another calculation.

The above aspects can be attained by a system that provides complex pricing for multiple electronic exchange, ASP or portal events such that individual events can be priced, cross product events can be priced, cumulative events can be priced and non-transactional events can be priced. The system dynamically and automatically prices the events responsive to an electronic exchange, portal or ASP event pricing plan that includes a decision network having rules with conditionally executed pricing algorithms. The algorithms include of single unit, double unit, taper discount, tier charge, tier discount, percent, flat, allowance, minimum, maximum, accumulation, threshold, multi-unit and taper charges.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts components of the present invention.

FIG. 2 shows the software architecture of the present invention.

FIG. 3 shows the functions performed during event pricing.

FIG. 4 shows a conventional pricing scenario.

FIG. 5 shows a volume discount pricing scenario that can be implemented using the present invention.

FIGS. 6-16 provide detailed view of the price plan for the scenario of FIG. 5.

FIG. 17 depicts the rule tree for the pricing plan noted in FIGS. 6-16.

FIG. 18 shows a step transaction pricing scenario that can be implemented using the present invention.

FIGS. 19-32 provide detailed view of the price plan for the scenario of FIG. 18.

FIG. 33 depicts the rule tree for the pricing plan noted in FIGS. 19-32.

FIGS. 34 and 35 show event pricing for events using a plan similar to that of FIGS. 19-32.

FIGS. 36-45 provide detailed view of a further complex price plan that provides discounts responsive to customer classification.

FIG. 46 depicts the rule tree for the pricing plan noted in FIGS. 36-45.

FIG. 47 shows buyer and seller components involved in a pricing transaction.

FIG. 48 illustrates relationships that are supported by the present invention.

FIG. 49 shows the relationship of the present invention to other software components in an electronic exchange.

### DESCRIPTION OF THE PREFERRED EMBODIMENTS

The present invention is directed to a system for dynamically pricing electronic transactions with a high degree of sophistication for electronic exchanges, ASPs or portal/e-marketplaces. The system enables transactions (any “events” that are part of customers' exchange portal experience) to be flexibly priced in a manner that is currently not found in B2B e-commerce. Any transaction or other event can be considered in conjunction with any other event for the purpose of determining rules-based discounts or rate structures with a high degree of sophistication. All events that are part of the exchange, portal or ASP session, or any related sessions for a specified period (e.g., yearly, monthly, daily), are eligible for price determination using the present invention.

In accordance with the present invention, rules can be and are devised to apply rates or discounts to a set of events based upon: 1. the characteristics of these events, or 2. the characteristics of an entirely different set of events.

An example of the first case (the characteristics of these events) is a transaction fee based upon a percentage of the charges for the ordered goods, followed by a tiered discount providing a monthly credit based upon the volume of the transactions. Other rules that could be provided in the first case include specified discounts based upon the particular products ordered, or even based upon any attributes of the order. The specific rules applicable are allowed to depend upon the supplier, such that unique rules are applied for each supplier and/or buyer in a given exchange, portal or ASP.

An example of the second case (the characteristics of an entirely different set of events) is a transaction fee for one set of products, (such as pencils, paper, and simple office supplies) based upon the charges or volume of another ordered good, (such as office furniture). Again rules are established to apply rates or discounts based on any attributes of the exchange, portal or ASP experience, within a particular session or across multiple sessions over a specified period.

The present invention enables all of these pricing relationships to be implemented through the use of rules-based software, via a graphical user interface (GUI). Thus, with the present invention, no new code will need to be developed to implement or modify pricing structures of this sophistication. A user will be able to define the pricing rules, the appropriate levels within a buyer's or supplier's customer organization, and the layout of the invoice or report generated from these events.

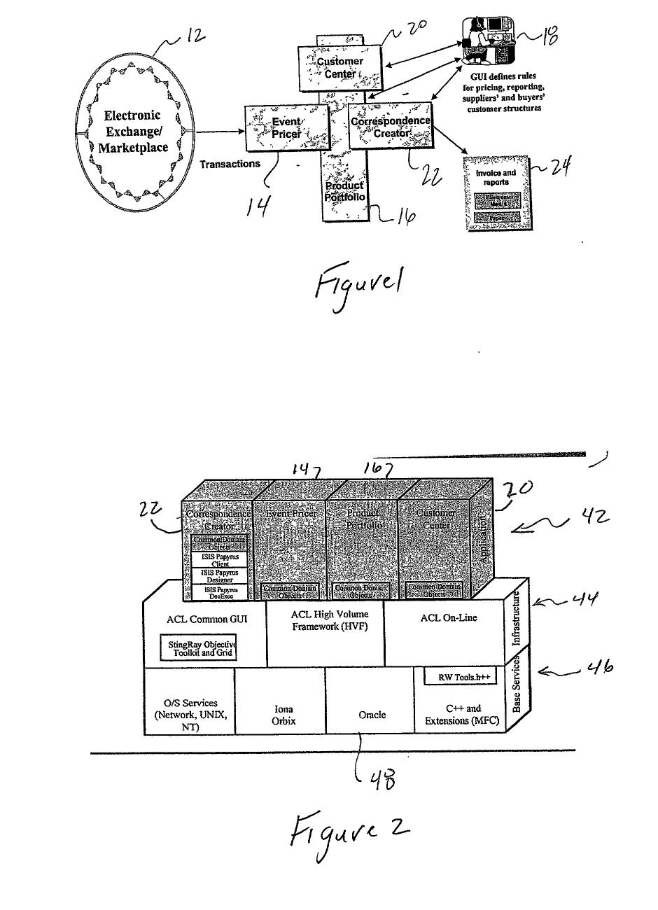

FIG. 1 depicts the system components of the present invention. Electronic transactions are performed by a conventional software based electronic exchange 12, such as that provided by Commerce One of Pleasanton, Calif. The software performs an exchange function such as matching a buyer with a seller and produces a transaction event. The transactions are provided to an Event Pricer 14, the primary component of the present invention, which applies charges for the transaction events and other events that can be captured throughout an electronic exchange session. The Event Pricer 14 applies sophisticated rules of the type described above and in more detail below, by traversing a pricing plan decision network and comparing the available characteristics of each event to the rules defined within an applicable pricing plan, as will be discussed in more detail later herein. The Event Pricer 14 applies charges and accumulates summaries in real-time, enabling charge information to become immediately available for viewing by any authorized external entity.

A Product Portfolio 16 provides a graphical user interface (GUI) 18 that allows or enables a user to define pricing plans, such as would be set forth in a product catalog. In this situation, the decision networks are defined graphically, establishing test conditions for attributes of the events or customers that will be processed by the Event Pricer 14. A Customer Center 20 provides a GUI that enables the buyers' and suppliers' customer structures to be graphically defined. That is, information about buyers and sellers is provided through the Customer Center 20. Through this mechanism, rates and discounts can be aggregated at any level of these customers' structures, and resulting charges may be allocated to any other level of these structures as well.

As an example, the present invention enables buyer aggregation, by allowing related buyers—such as owners of a series of franchises—to accumulate transaction volumes collectively, to achieve a particular discount tier level. The invention then enables the resulting transaction charges or discounts to be allocated back to the individual stores, according to specified rules. For example, the allocation may be based upon a fixed percentage, or may be based upon the contributing level of charges for each store.

A Correspondence Creator 22 provides a GUI that enables invoices or reports 24 for buyers and sellers to be generated in real-time, in a variety of media (including electronic media) that reflect the charges calculated by the Event Pricer 14.

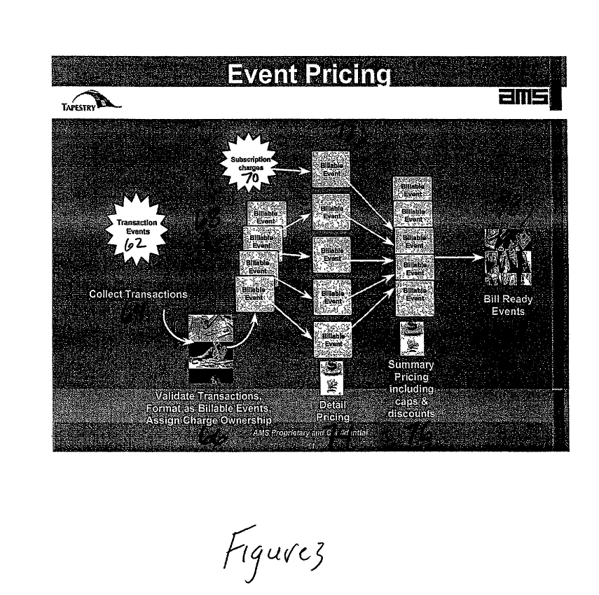

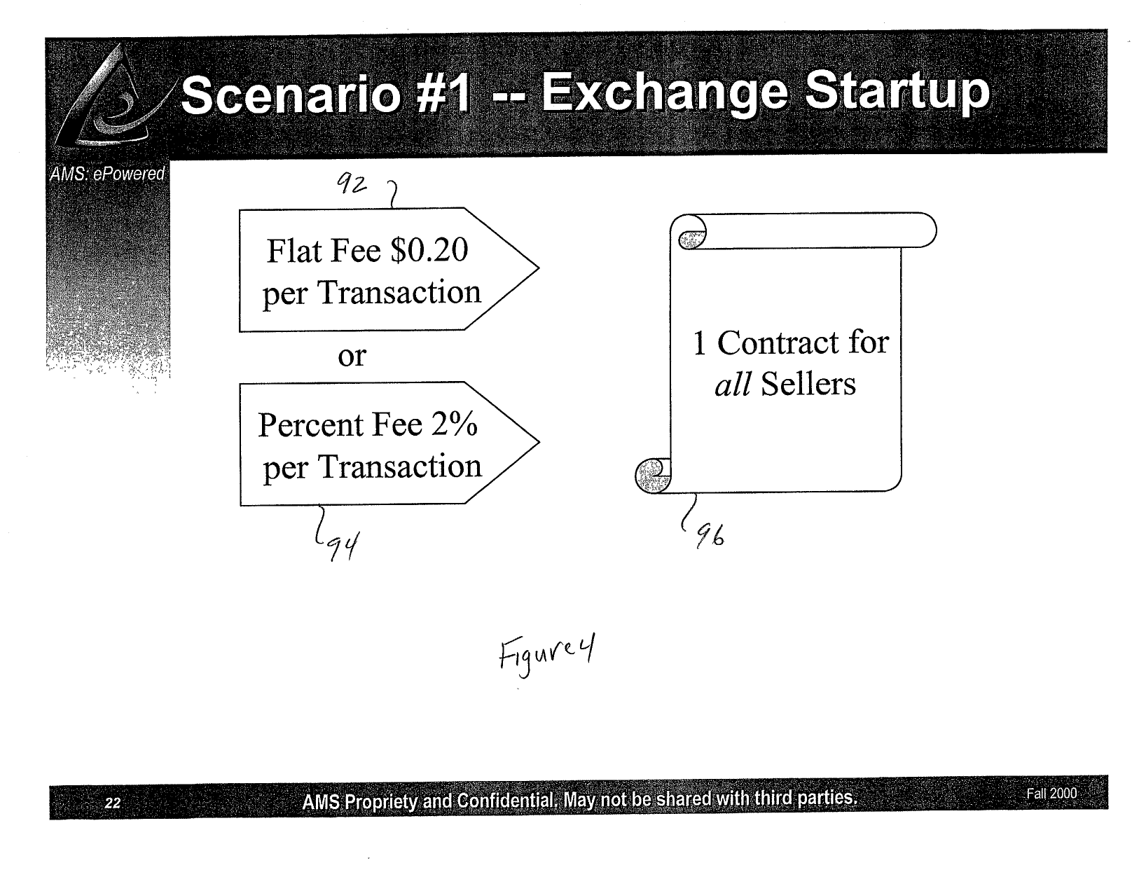

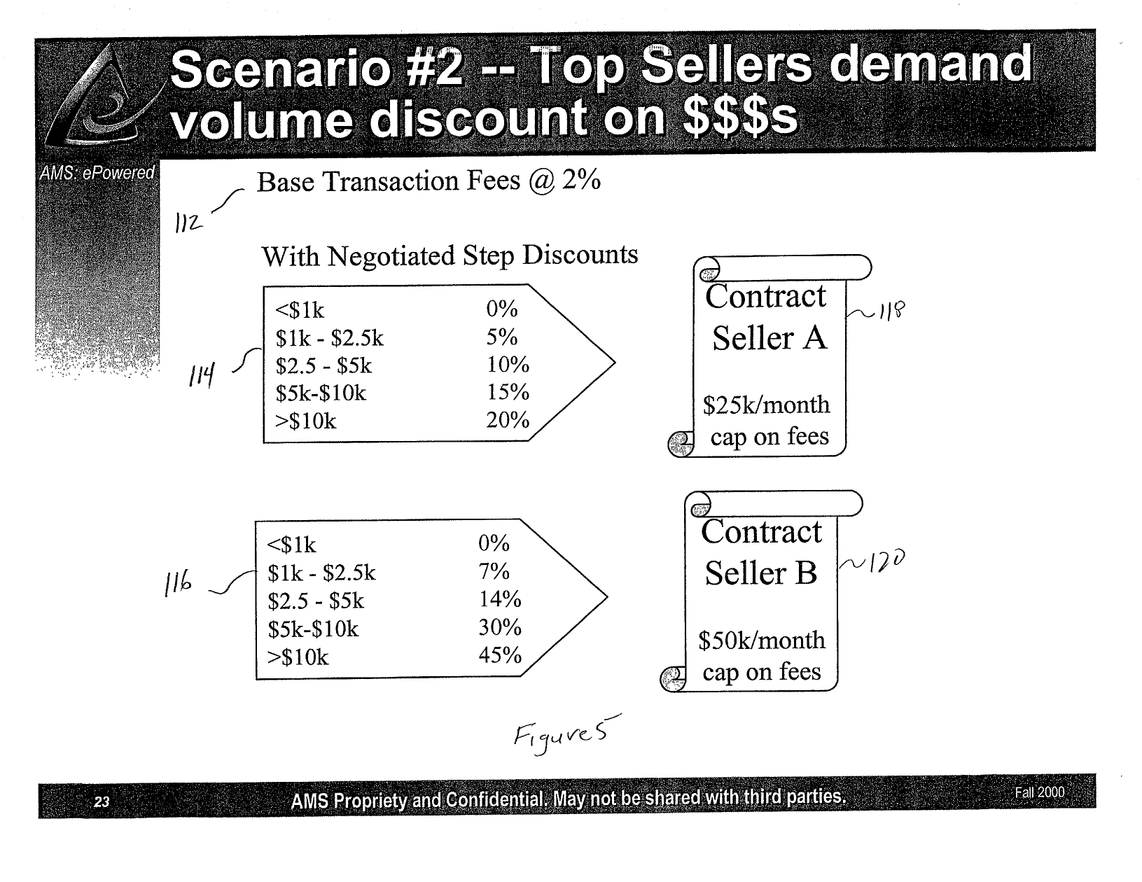

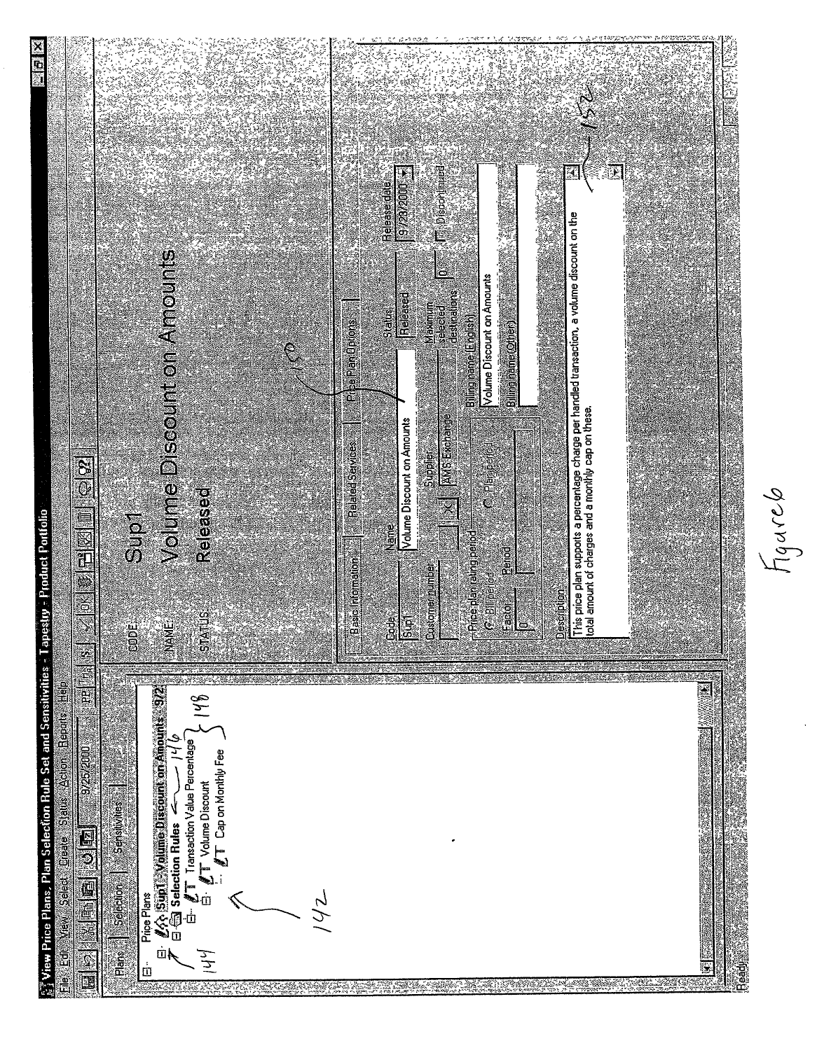

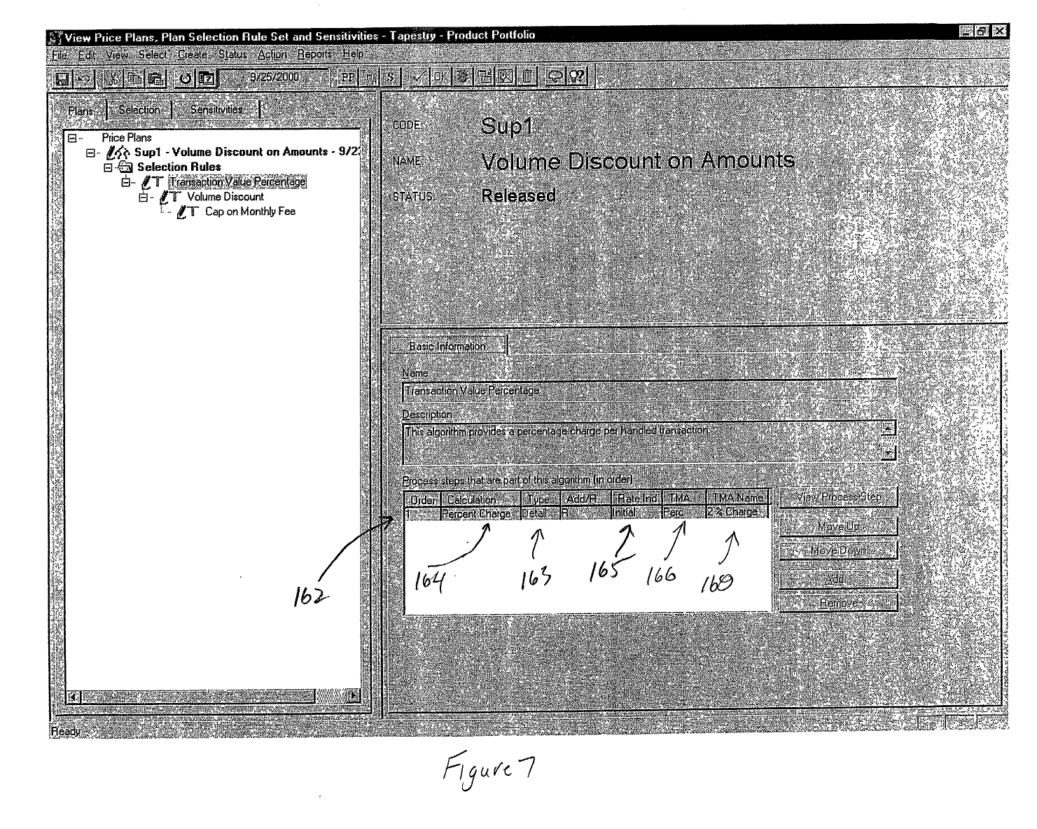

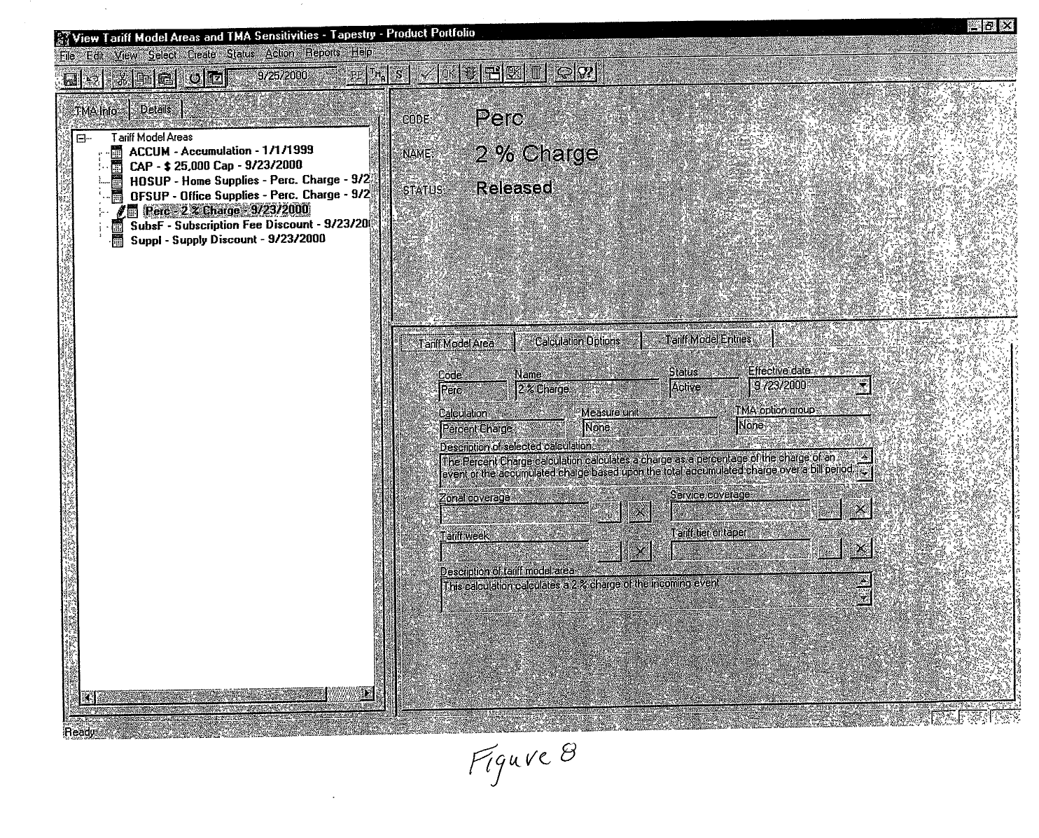

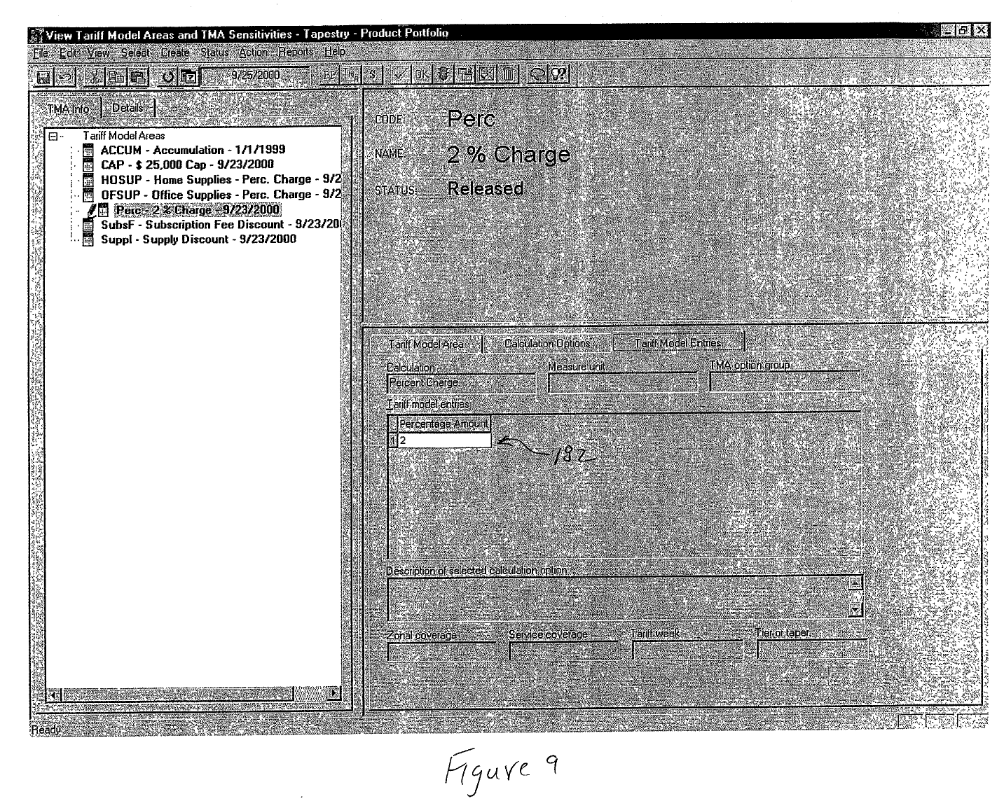

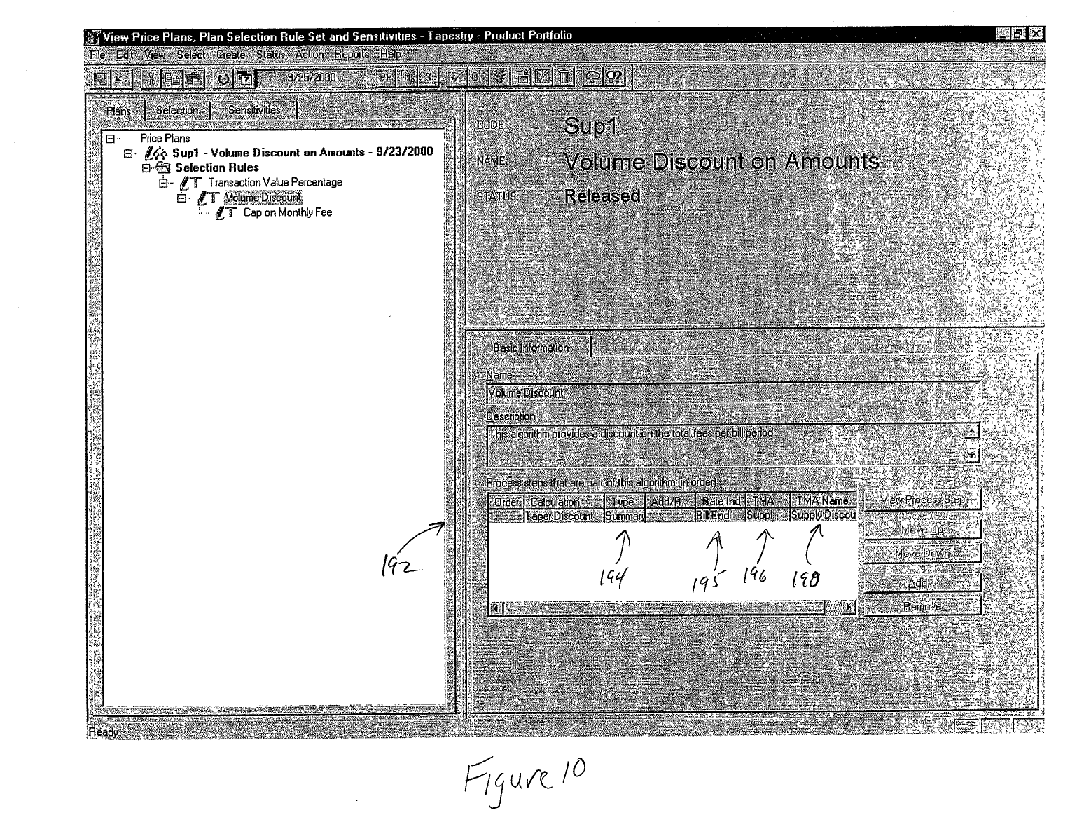

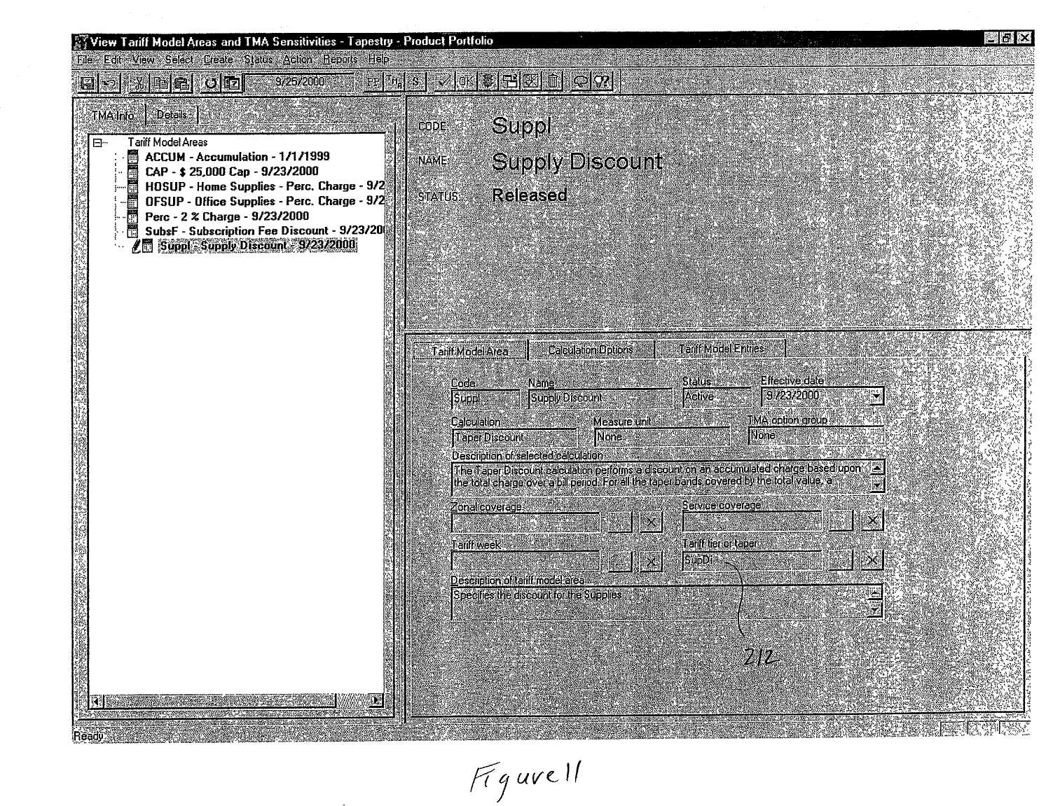

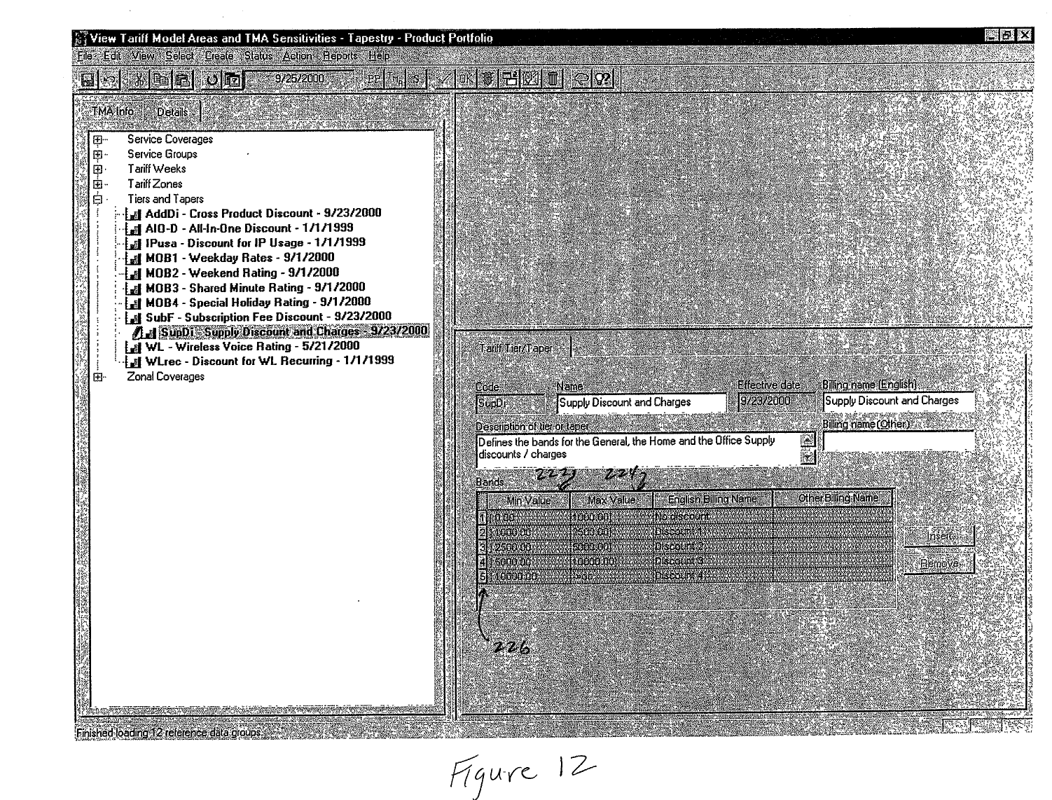

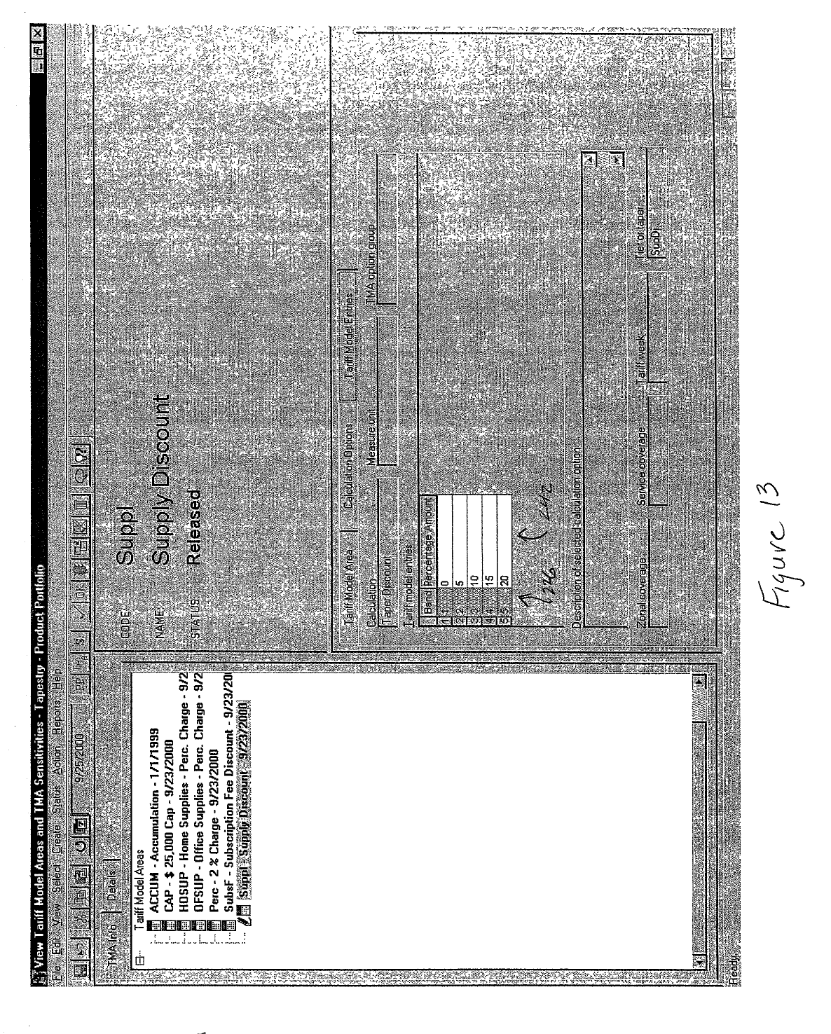

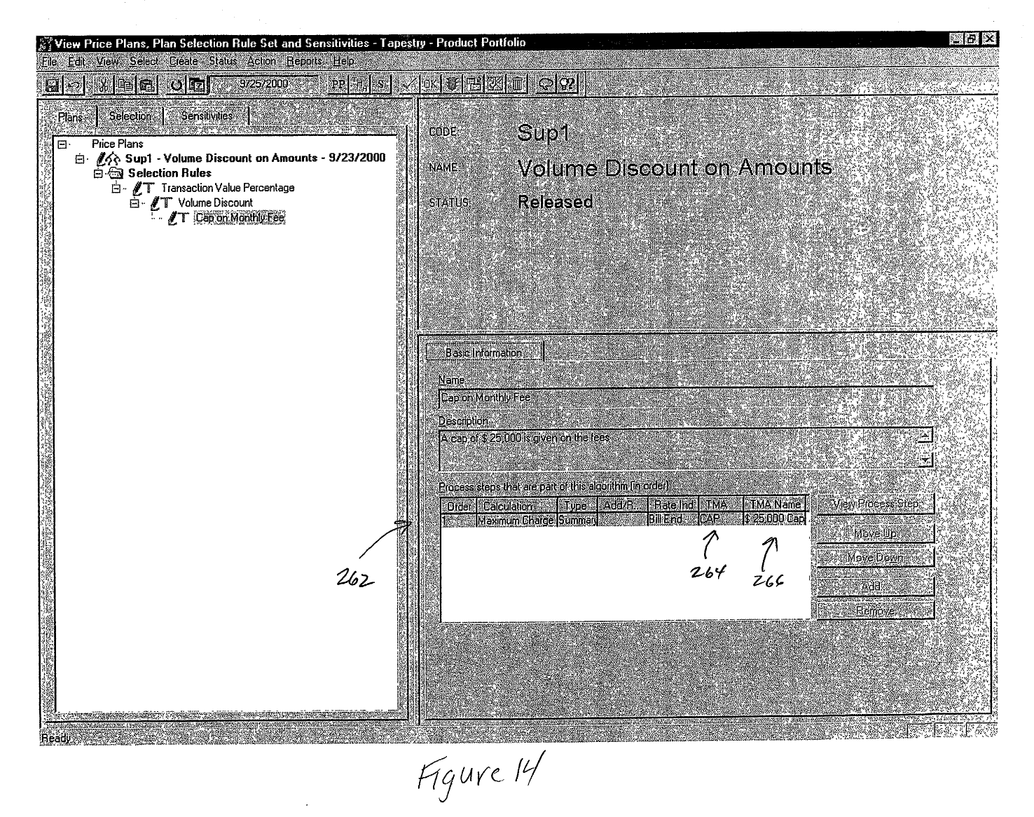

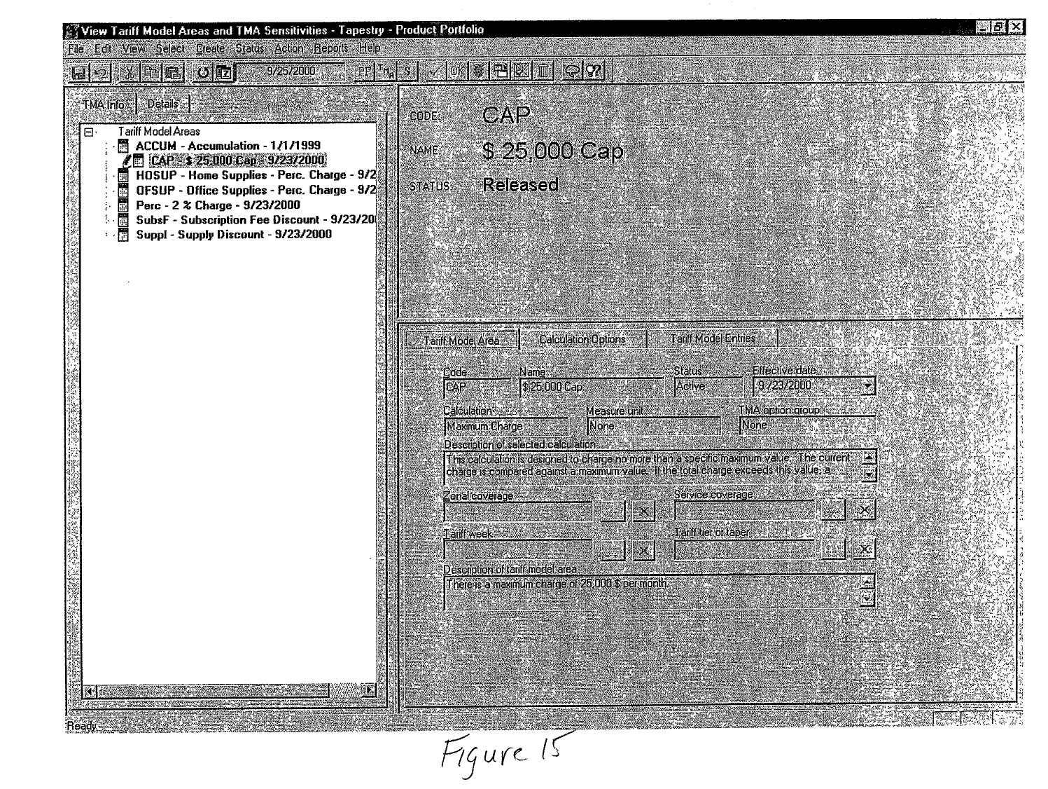

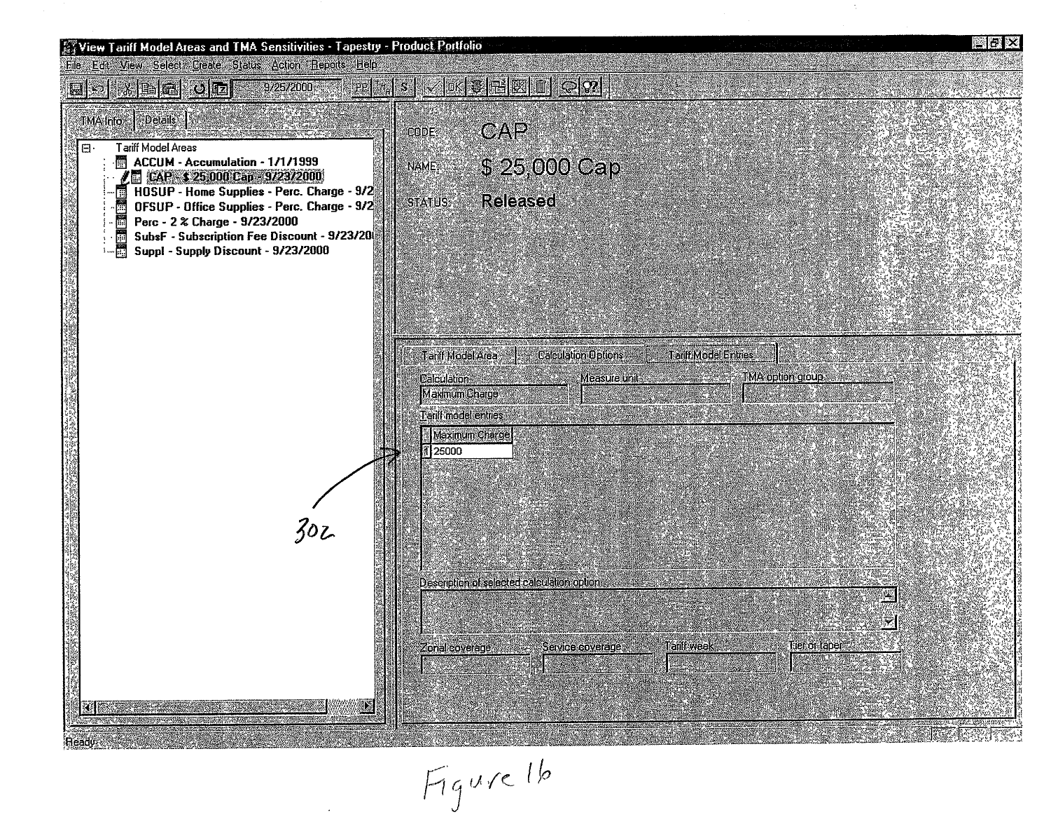

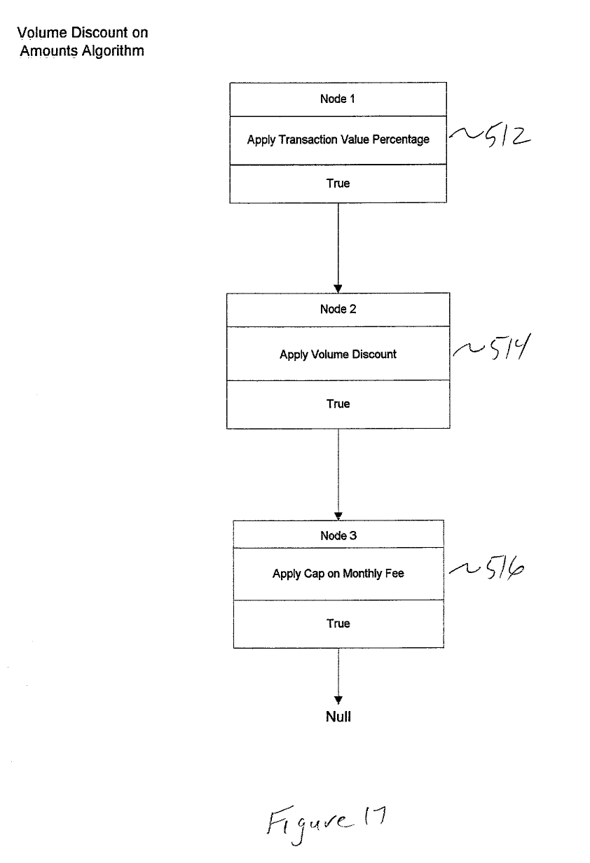

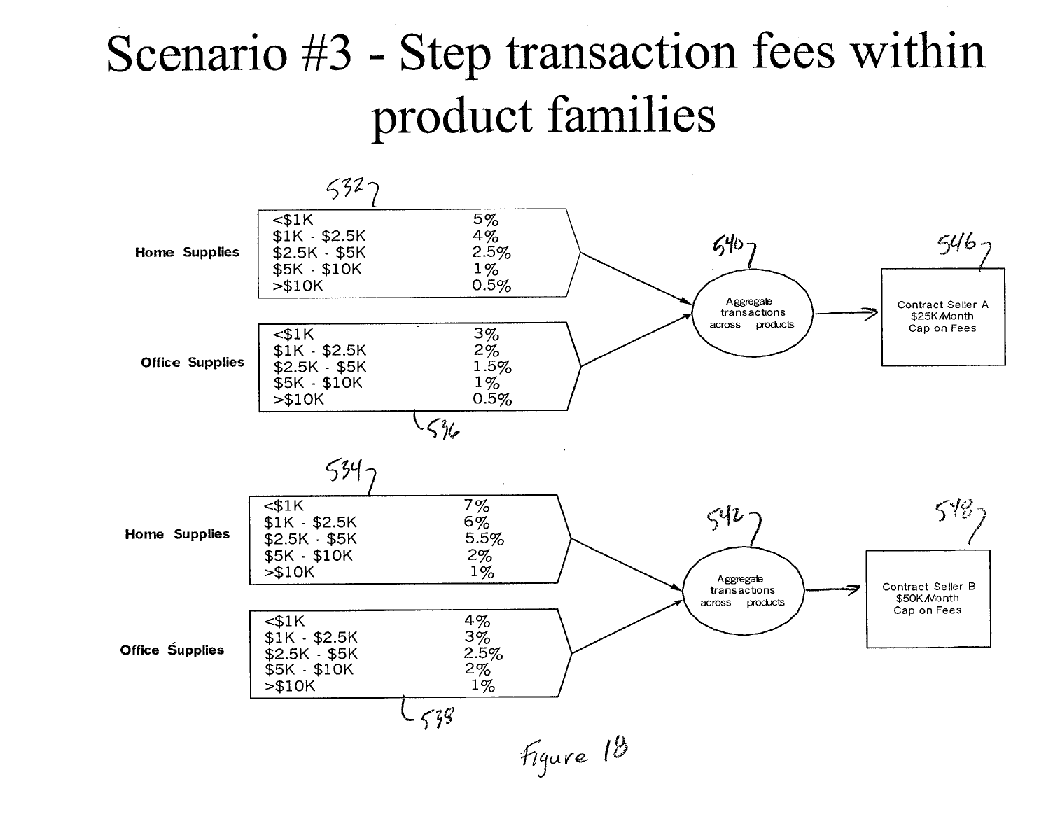

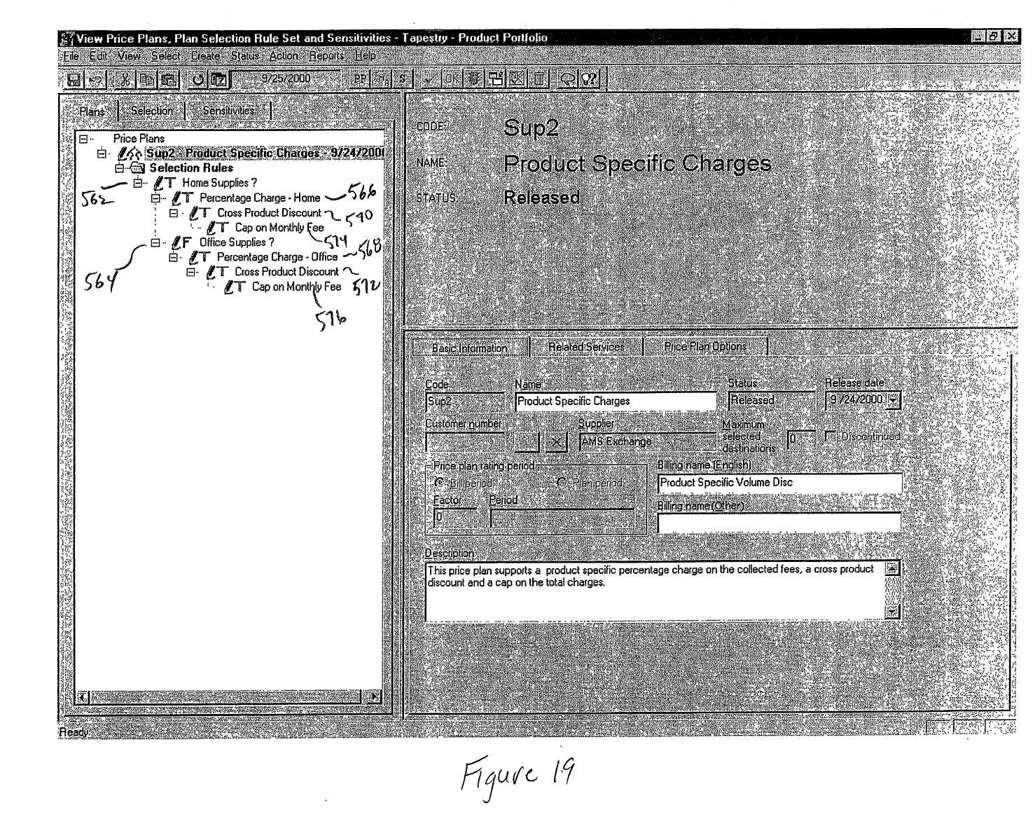

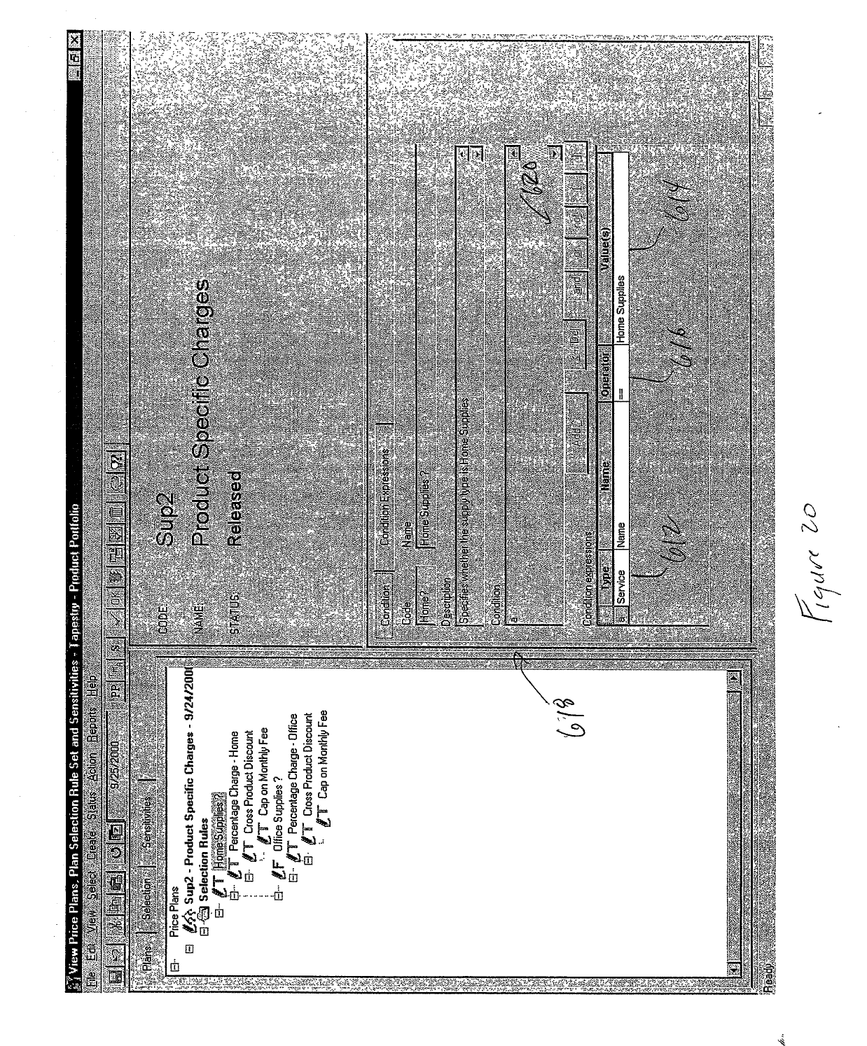

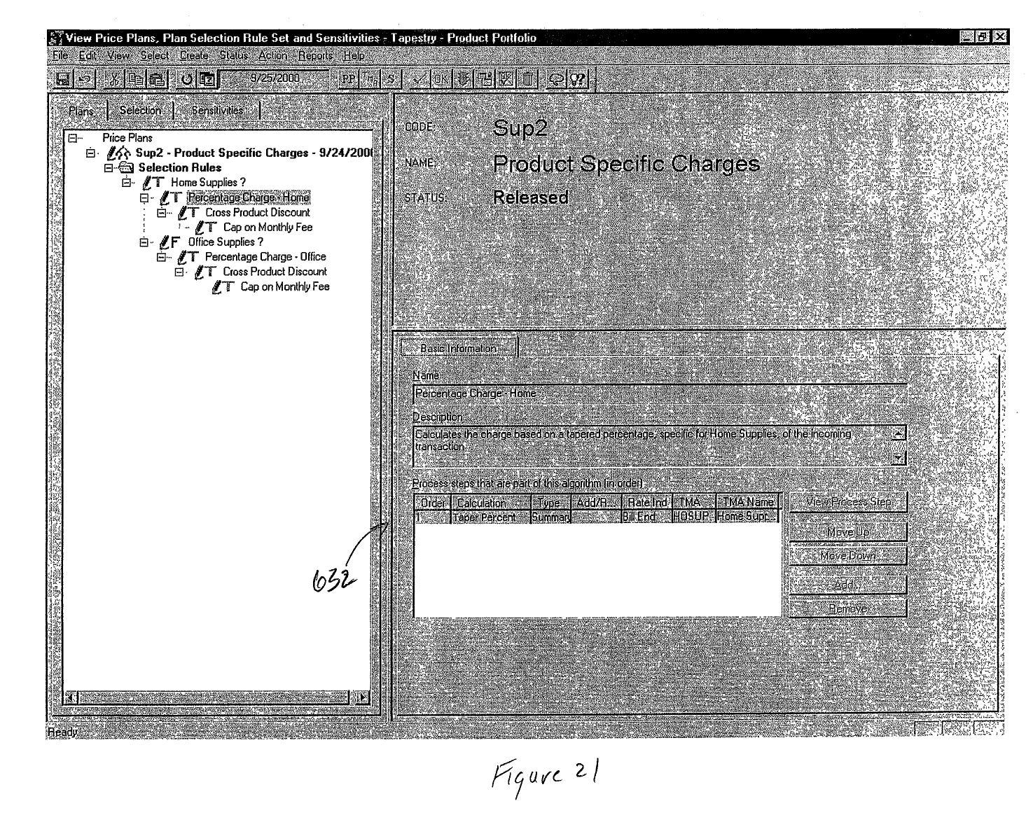

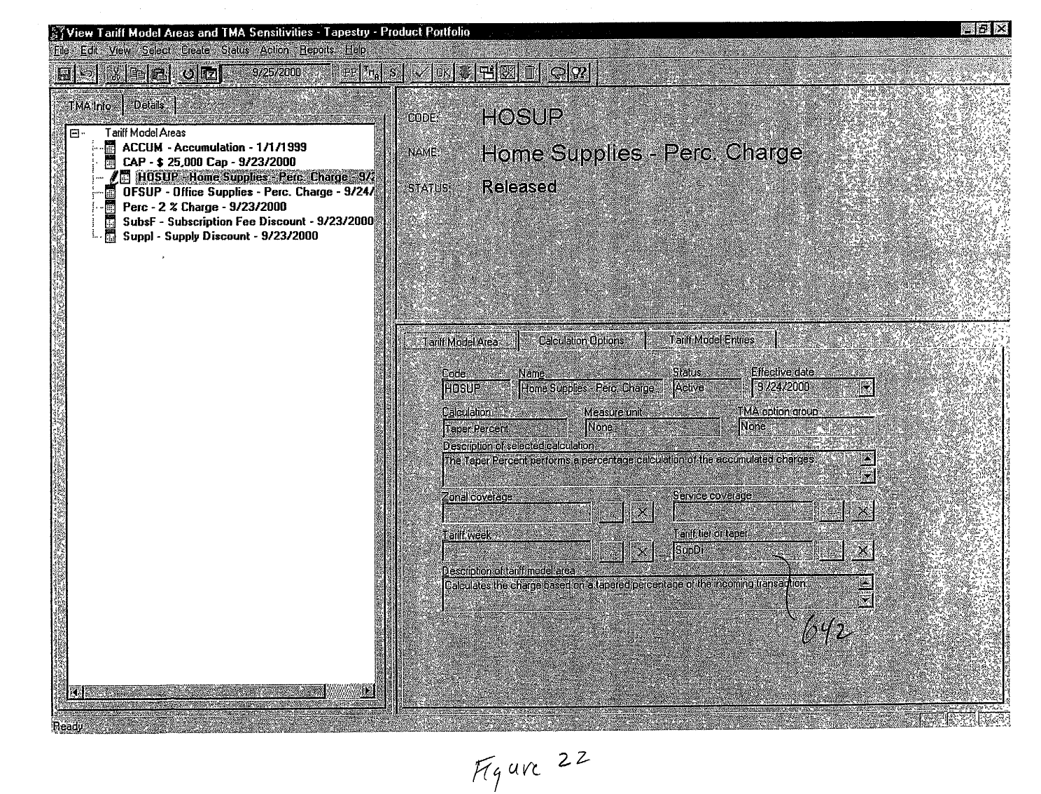

The preferred software architecture, as depicted in FIG. 2, is a three tiered architecture with the above identified software applications or modules 14, 16, 20 and 22 residing in an application layer 42. The application layer 42 interacts with an infrastructure layer 44 which interacts with a basic services layer 46. A database system 48, such as an Oracle system, stores the decision network and rules used by the Event Pricer 14 to price the events. Transactions requiring pricing arrive as files transferred via the O/S services component 50. The file is mapped to an object that is handled by the Pricer 14 to price the transaction. The results of the pricing of the transaction are returned to the exchange as a file which is used by the exchange to complete the transaction, such as notifying the seller/buyer as to delivery dates, etc. The Correspondence Creator 22 provides the buyer/seller with the cost information which includes the cost of the goods and the cost of the transaction.

FIG. 3 depicts the important functions or operations in the flow of processing of the present invention. All transaction events 62 are collected 64 by the exchange and then the events are validated, formatted and assigned charge ownership 66 as billable events 68. Charge ownership assignment involves determining what costs of the transaction are borne by the buyer and what costs of the transaction are borne by the seller. Other charges generated, including subscription charges 70, if appropriate, are also used as billable events 72 in association with the events in this or related sessions to determine rates or discounts applicable to any set of events defined. Two types of pricing occur: Detail Pricing 74 and Summary Pricing 76. Detail Pricing 74 is applied in real-time, using information about a given event, and any events that have been processed previously, using the price plan decision network and accumulated real-time into a summary. Summary Pricing 76 is applied to a collection of events, such as a cap on the total charge, when triggered within the decision network, for example when a billing period is complete, whether daily, monthly, yearly, or otherwise producing bill ready events 78.

Upon notification, Summary Pricing 76 determines that the accumulated charges or volumes pertaining to specific threshold levels, tier levels, or other values are concluded. Summary Pricing 76 therefore calculates a final rate or discount for these period-based pricing schemes, and provides the charge events to the same repository as the other transaction based events, where all are now bill ready events 78 to be applied towards an invoice, report, or statement of some kind.

The focus of the present invention is upon enabling flexible pricing of events transpiring within an electronic exchange using the Event Pricer 14. The Event Pricer 14 is code based while the rules used by the Pricer 14 are non-code based rules definable and tailorable to the particular pricing desired. The same problem can possibly be solved through extensive customization of the electronic exchange companies' current software code/assets. In fact, it is AMS's belief that without this invention, e-commerce will follow a similar trend to that found within telecommunications, where maturing companies must customize their pricing schemes to compete. An advantage of this invention is it will allow B2B exchanges to differentiate themselves from their competition before the trend forces the exchanges into extensive, and expensive, customization of their pricing software.

This same problem is applicable for any application of electronic commerce. While this invention has focused primarily upon B2B exchanges, which we perceive will have the greatest need for this invention, the invention is nevertheless applicable in any e-commerce activity. Pricing of all events throughout a “portal experience” could include such events such as a customer clicking on an advertising banner, clicking through to another site (even another exchange), and other such activities in addition to transactions captured by exchange software. The present invention is capable of pricing these events in association with other events, in the same manner as described above.

The present invention provides an unprecedented ability for B2B exchange transactions to be priced with a higher degree of sophistication, with user-defined rules that do not require customized code to be developed. An important feature is that transaction charges can be based upon any number of attributes yet-to-be-determined about the products purchased, the customers involved (buys and suppliers), and even other events transpiring during a buyer's exchange session. The power of the invention is that these events may be priced by traversing a decision network, in real-time, obviating the need for new code each time a complex scheme is devised to differentiate an exchange from its competition.

The Event Pricer 14 provides event driven, real-time, transaction processing using rules that accommodate a wide variety of sophisticated pricing/discounting plans that includes customer negotiated rates and hierarchical discounts which are handled flexibly with user defined rules. Event handling by the Pricer 14 includes retroactive re-rating (canceled transactions, rate changes, etc.) and errors and exceptions. The Pricer 14 is scalable for large transaction volumes.

The present invention supports a number of different pricing scenarios for electronic exchanges including customer negotiated pricing structures, such as customer-specific discount percentages as well as taper and tier thresholds tailored to specific customers and/or product sets. With the present invention complex customer structures may be implemented to enable special pricing relationships, e.g., buyer aggregation is supported, as affiliated customers may accumulate towards volume pricing levels and then be allocated and holding company and subsidiary relationships are supported, enabling sophisticated arrangements as needed, whereby discounts are applied based upon multiple levels of aggregation. The invention supports promotional offerings providing special rates and discounts for a limited period, such as new customers' first three months priced specially (e.g., free). The invention allows discount periods to be independent from monthly bill periods, e.g., transaction volume over a twelve month period may determine a tiered discount applied yearly, or at the end of a contract period. The invention allows the reporting of rates and discounts, accumulated in realtime, across user-defined customer profiles. Location based charges, such as those associated with cost of doing business, may vary by originating customer location (taxes may vary too); as well as the transaction price. Rates depend upon quality of delivery service can also be provided, e.g., a ratio of orders fulfilled versus orders taken, over time affects the transaction price. Time based charges, such as busy seasons and/or holiday periods, may be priced differently as well as peak hours may incur more expensive transaction costs to encourage load balancing, when staff are overburdened with manual order fulfillment activities. The invention also incorporates subscription based fees that can be applied variably (monthly, quarterly, yearly, etc.). Of course, transaction based fees applied on a usage basis are allowed. Different types of rates are also allowed, such as a flat fee per transaction, a percentage of transaction, a maximum charge ceiling, a minimum charge cap, a tapered/step charge functions, a tiered/volume charge, etc. Discounts can also be used, such as allowances, e.g., first X transactions free, first $X free, first X months free, tapered/step discounts, tiered/volume discounts, and thresholds, e.g., once transaction level achieved for one supplier and/or product, apply discount for these charges, or for another set of charges (e.g., discount on total charges).

The above pricing scenarios are supported by a number of different pricing mechanisms or algorithms as discussed below.

A Single Unit pricing mechanism prices an event based on volume or quantity. In this mechanism, a single charge is generated or calculated per event or for all of the qualifying events in the bill period, based upon the combined volume or quantity of these occurrences. Once all the usage has been aggregated, the total volume/quantity is converted into the number of units (so that, in the case of volume, a charge per item, per category of item (e.g., home or office supplies), or per any other unit or multiple of units is possible). The resulting number of units is multiplied by the charge rate (e.g., $1.00 per unit), yielding a total charge for the transaction. Rounding during aggregation is driven by indicators as well as the final charge rounding.

A Double Unit pricing mechanism calculation calculates a charge per event or for all of the qualifying events in the bill period, based upon the combined volume or quantity of these occurrences. A base charge is assigned for any units, although this charge may be $0.00 if some units are allowed for free due to a recurring charge. The initial charge covers any usage up to and including the initial unit, if the volume/duration exceeds a minimum initial unit amount (i.e. if the minimum is 1 unit, the unit is 5 items and the transaction involved less than five items, no initial charge is applied). The transaction is charged an additional amount when the total volume/quantity exceeds the initial unit. In this case, the remaining volume is portioned into incremental units and each incremental unit is charged the incremental unit charge amount if the remaining volume exceeds the minimum successive unit amount. Rounding during aggregation is driven by indicators as well as the final charge rounding.

A Taper Discount pricing mechanism calculation performs a discount on an accumulated value of volume, quantity or charge based upon the total usage over a bill period. For all the taper bands covered by the total value, a percentage discount is applied on the value qualifying for the band covered. Final charge rounding is driven by an indicator and a precision value if necessary.

A Tier Charge pricing mechanism calculation applies a charge on an accumulated value of duration or quantity based upon the total usage over a bill period. For the tier band the total value falls into, a charge is calculated by multiplying the number of units by the charge amount. Rounding during aggregation is driven by indicators as well as the final charge rounding.

A Tier Discount pricing mechanism calculation performs a discount on an aggregated value of volume, quantity or charge based upon the total usage over a bill period. For the tier band the total value falls into, a percentage discount is applied on the total value. Rounding during aggregation is driven by indicators as well as the final charge rounding.

A Percent Charge pricing mechanism calculation calculates a charge as a percentage of the accumulated charge based upon the total usage over a bill period. Depending on the discount indicator, this charge is discounted or added to the aggregate charge. Rounding during aggregation is driven by indicators as well as the final charge rounding.

A Flat Charge pricing calculation applies a flat charge (usually a surcharge, e.g. $1.00 US per transaction). Depending on the discount indicator, this charge is discounted or added to the aggregate charge.

A Charge Allowance mechanism calculation allows a charge to be used for free over a bill period. If the accumulated charge does not exceed the specified allowed charge, no charge is applied. Rounding during aggregation is driven by indicators and precision values if necessary.

A Minimum Charge pricing calculation is designed to charge at least a specific minimum value. The total summary charge is compared against a minimum value. If the total charge fails to meet or exceed this value, a penalty charge is calculated to offset the difference between the summary charge and the minimum. Rounding during aggregation is driven by indicators and precision values if necessary.

A Maximum Charge pricing mechanism calculation is designed to charge no more than a specific maximum value. The total summary charge is compared against a maximum value. If the total charge exceeds this value, the charge is replaced by the maximum value. Rounding during aggregation is driven by indicators and a precision values if necessary.

An Accumulation calculation does not perform any rating or pricing charge evaluation. It accumulates the volume, quantity and charges over a bill period. This aggregated value is used in subsequent calculations that are explicitly linked for tier/taper evaluation. Rounding during aggregation is driven by indicators and precision values if necessary.

A Threshold calculation compares the accumulated volume, quantity or charges over a bill period with a defined amount. If the threshold is reached, the return value is TRUE, otherwise it is FALSE. This return value is used to perform or not a subsequent calculation that is explicitly linked. Rounding during aggregation is driven by indicators and precision values if necessary.

A Multi-unit pricing mechanism calculation applies a charge to a single event. The charge depends on a taper definition. For each proportion of the event (based on its volume compared to the taper band), a charge amount is applied.

A Taper Charge calculation applies a charge on an aggregate value of volume, quantity or charge based upon the total usage over a bill period. For all the taper bands covered by the total value, a charge is calculated using a single unit calculation. Rounding during aggregation is driven by indicators as well as the final charge rounding.

The present invention provides a number of different benefits for B2B electronic exchanges. The present invention provides a competitive advantage in allowing a quick reaction to customized contract pricing situations. The invention also provides an ability to support special offers not possible with traditional exchange software packages and thereby win the business of large corporations who can achieve favorable volume pricing conditions and retain customer loyalty by reflecting savings with reports. The invention additionally allows real-time event handling of retroactive changes, such as cancellations, rate changes, etc. and the reconciliation of detail transactions with summary charges.

The present invention can be implemented by a person of ordinary skill in the art familiar with the patent applications previously noted and with the TAPESTRY product available from American Management Systems.

Below will be disclosed four scenarios and three price plans corresponding to scenarios 2, 3 and 4. Pricing plan structures for each of the scenarios are depicted in the form of a GUI screen shot of the plan structure “tree” or decision network. The results of pricing a set of transactions are shown in charges pricing screen shots for scenario 3. Following each of the scenario depictions are detailed GUI views of the price plans for the scenarios and a view of the plan structure tree as it is used in executing the plan in accordance with the systems described in the related applications noted above.

The first scenario (Scenario #1—Exchange Startup) depicted by FIG. 4 illustrates the typical scenario encountered and accommodated by conventional pricing mechanisms of electronic exchanges. Either a flat fee 92 for each transaction or a percentage 94 of the value of each transaction is applied by contractual arrangement with the exchange.

The first price plan (Price Plan 1—Scenario #2—Volume Discount On Amounts), as depicted in FIG. 5 determines a base transaction fee 112 based upon 2% of the goods purchased. The plan also offers additional volume discounts 114 and 116 based on contractual arrangements 118 and 120 with the different sellers for high volumes for suppliers selling high volumes of goods on the exchange, and provides for a monthly cap (maximum) on the transaction fees. Each step in this complex pricing chain can be defined and configured through the use of rules, with no need for new code.

As depicted in FIG. 6, the GUI shows, in the left side window 140, the true/false tree or decision network structure 142 of Price Plan 1 (see FIG. 17 for an example of the decision network as a network diagram) where the tree includes a name branch 144 with a selection rules definition folder 146 which includes the rules and selection criteria for the calculations to be performed. This plan includes three operations or rules/calculations 148 that are executed when the event is true (“T”). The first of the calculations being a percentage calculation, the second a volume discount calculation and the third being a cap on the total charge. FIG. 6 depicts in the right side window the plan name 150 and a description 152.

FIG. 7 shows the basic information for the transaction percentage applied to each transaction. The process operations include a percentage charge calculation or algorithm (a single operation) 162 which is defined as a detail type 163 event calculation which is performed at a timing 156 at the initial entry of each transaction. The operation 162 has a percent charge calculation 164 having a tariff model area (TMA) 166 defined as percentage (“Perc”) and a name 168 for this charge of “2% Charge”. The TMA field essentially points to an entry in a tariff model entry database which, as depicted in FIG. 8, holds the TMA for this calculation and depicts a 2% charge with no additional sensitivities, such as where the product is made (zone), the time (week), etc. FIG. 9 shows the actual percentage 182 used in the calculation. Multiple such operations can be included in any one node.

FIG. 10 shows the basic information for a volume discount. This process includes a Taper Discount calculation or algorithm 192, which is defined as a summary type 194 calculation having a TMA 196 defined as a supply discount (“Suppl”) and a name 198 for this charge of “Supply Discount”. A summary calculation is performed on an aggregate of events at a timing 195 defined as the “Bill End”. FIG. 11 shows the TMA for this calculation in more detail and depicts a charge calculation with additional calculation sensitivity for a tier or taper charge 212 having the code “SupDi” (Supply Discount). Note that FIG. 11 also shows that the system accommodates a number of reusable tariff models. FIG. 12 shows the minimum 222 and maximum 224 values for each of the discount bands 226 of the taper. FIG. 13 depicts the percentage amount 242 associated with each of the bands 226.

FIG. 14 shows the basic information for the cap on the monthly fees. This process includes a Maximum Charge summary type calculation 262 having a TMA 264 defined as a cap (“CAP”) and a name 266 for this charge of “25,000 Cap”. FIG. 15 shows the TMA for this calculation in more detail and depicts that no additional calculation sensitivities are involved. FIG. 16 shows the amount of the maximum charge 302.

The decision network for the pricing plan discussed above includes three nodes 512, 514 and 516 each of which is an algorithm which is applied each time the tree is traversed. For example the transaction percentage 512 is applied for each event while the volume discount 514 is applied when the end of the billing period is reached as is the cap 516.

The second price plan (Price Plan 2—Scenario #3—Product Specific Charges), as depicted in FIG. 18, offers different transaction fees based upon whether home 532/534 or office 536/538 supplies are sold. Different transaction percentages apply within these product families, according to different taper (step) schedules, whereby as volumes increase, the transaction percentage is lowered. A cross-product discount 540/542 applies for volumes across both these product groups, and maximum caps 546/548 on transaction fees also apply across product families.

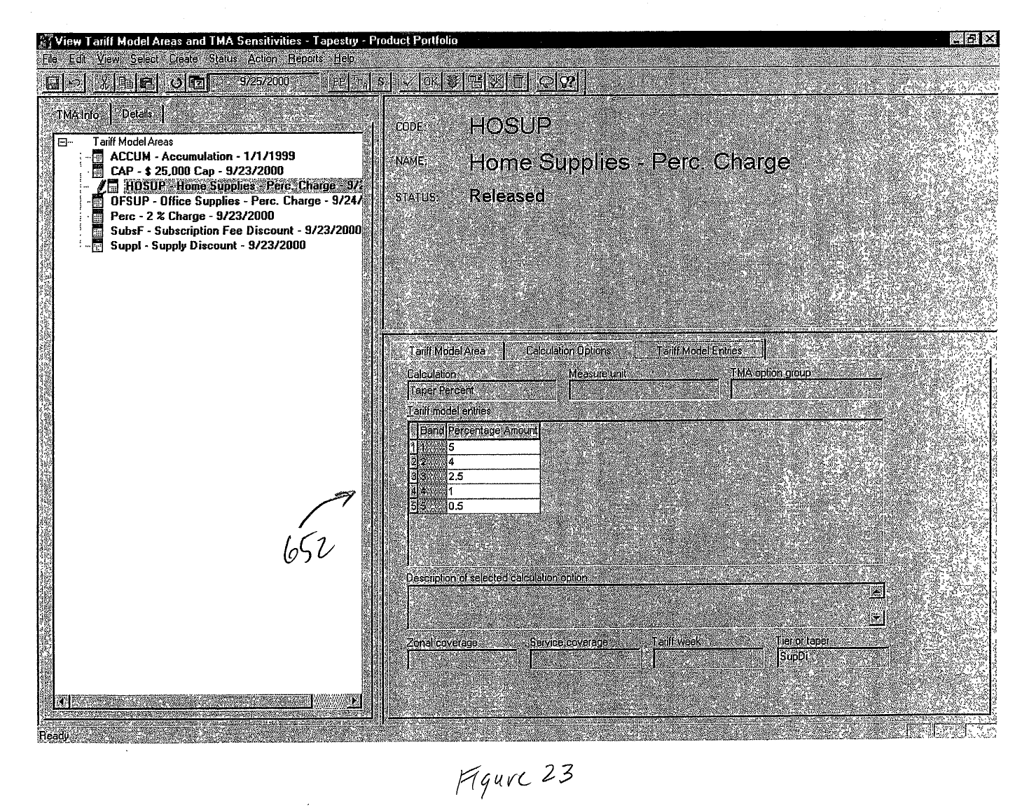

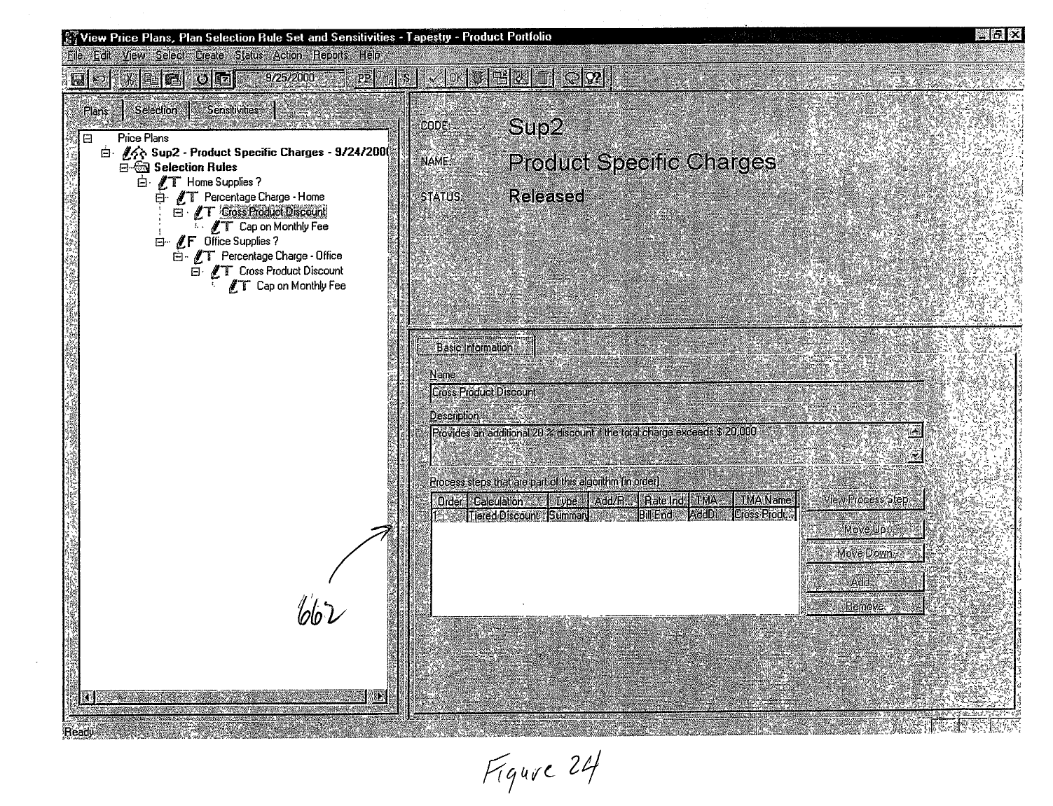

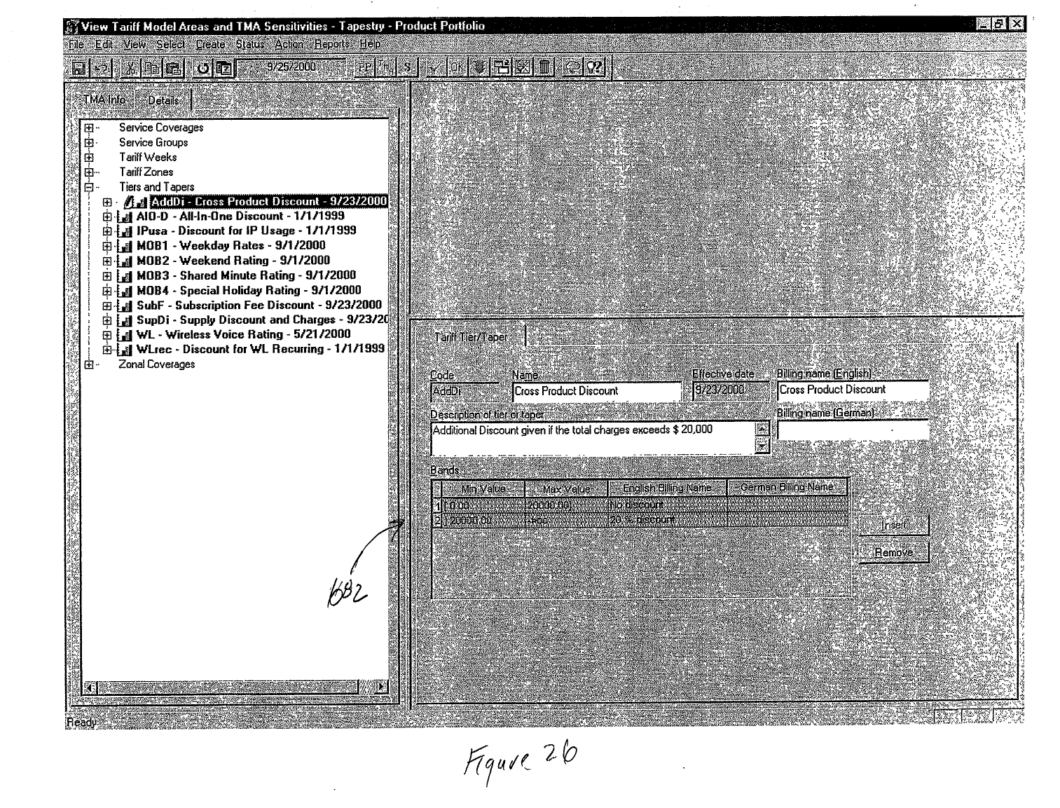

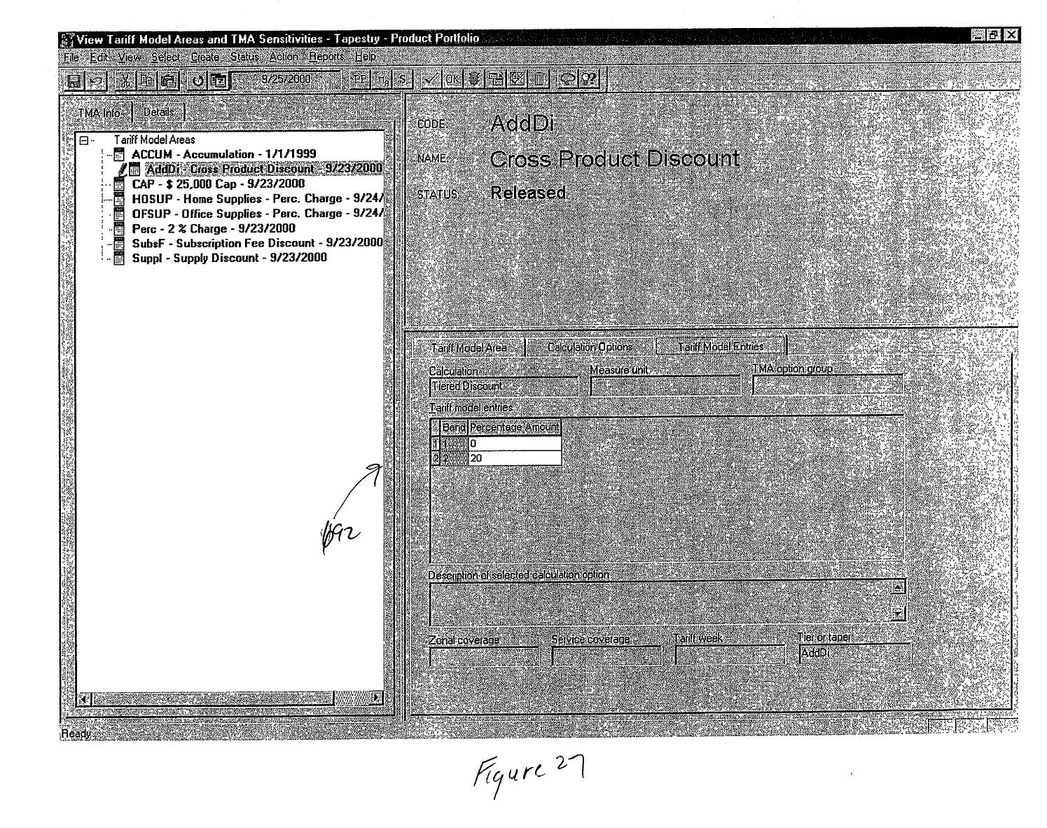

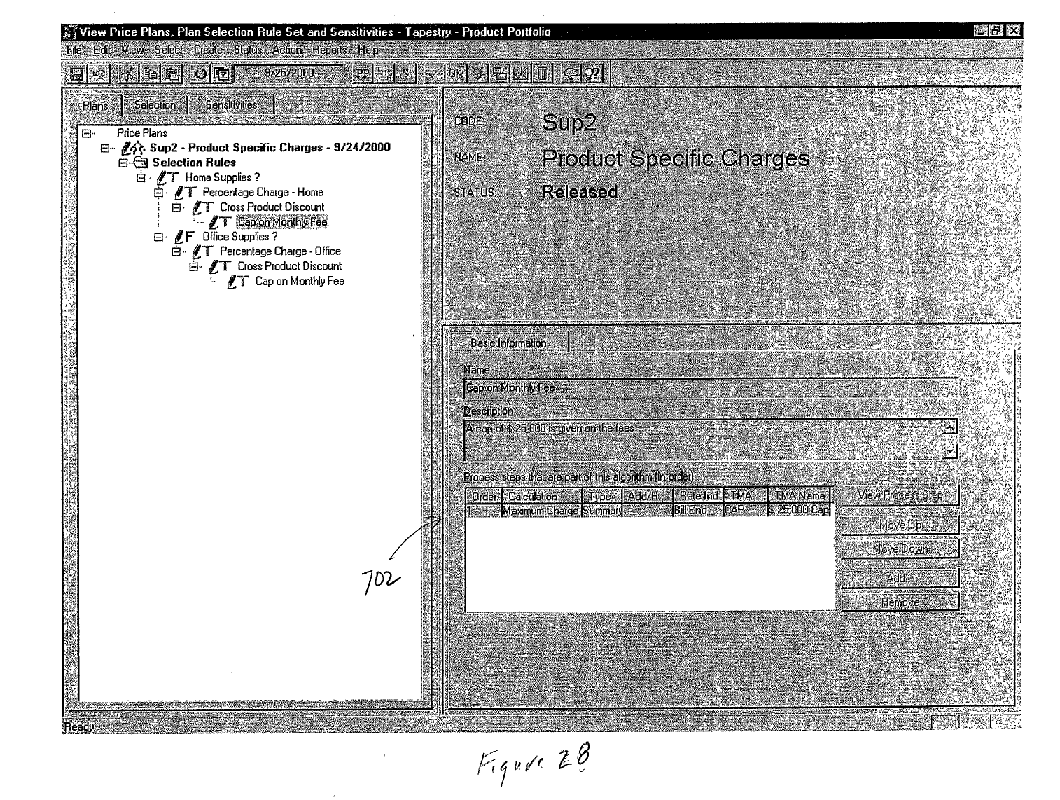

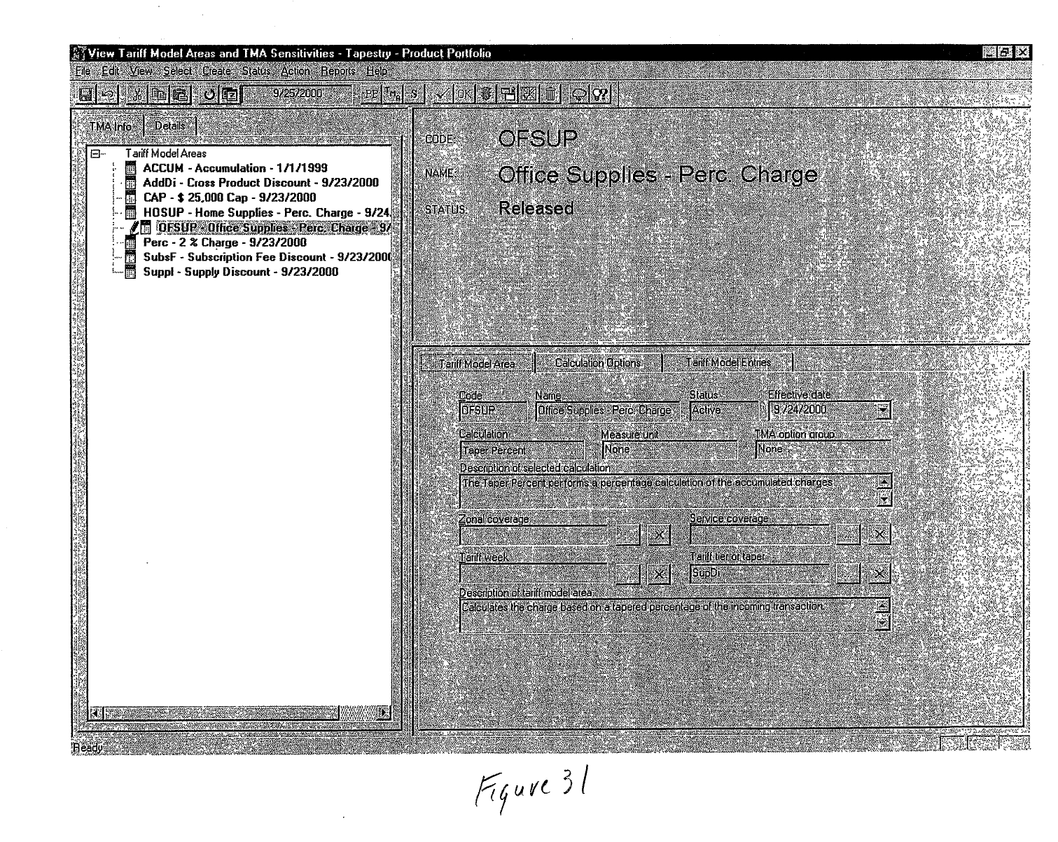

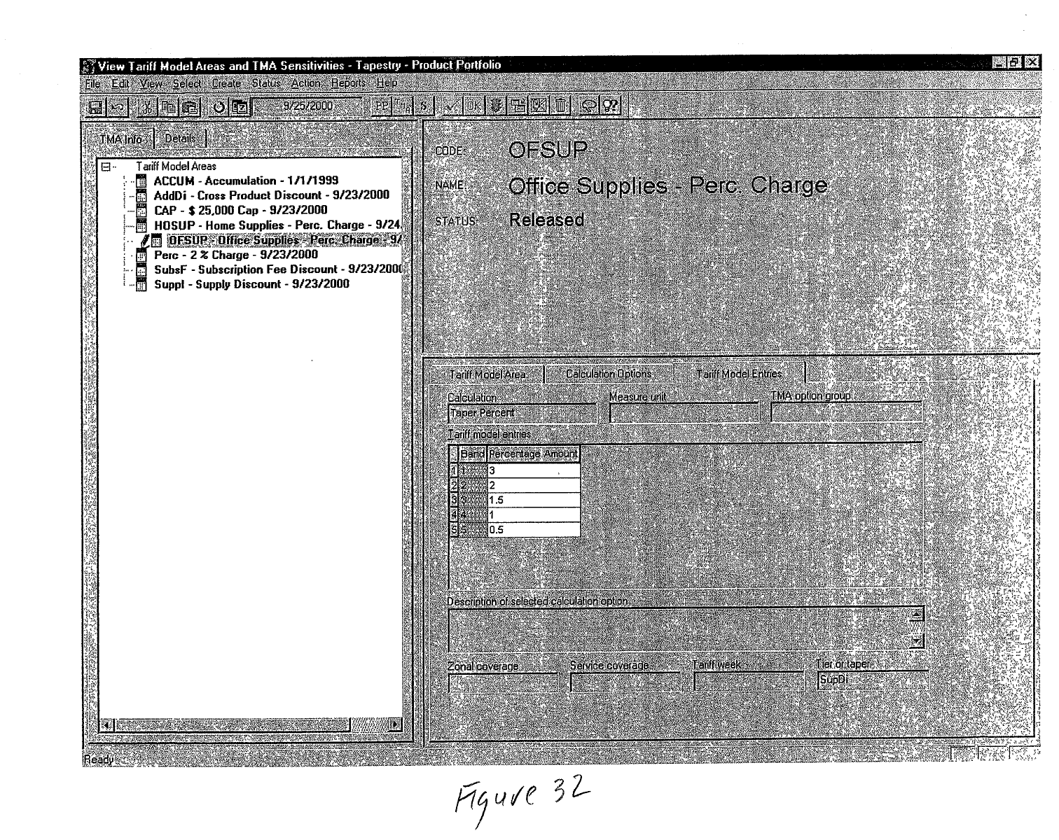

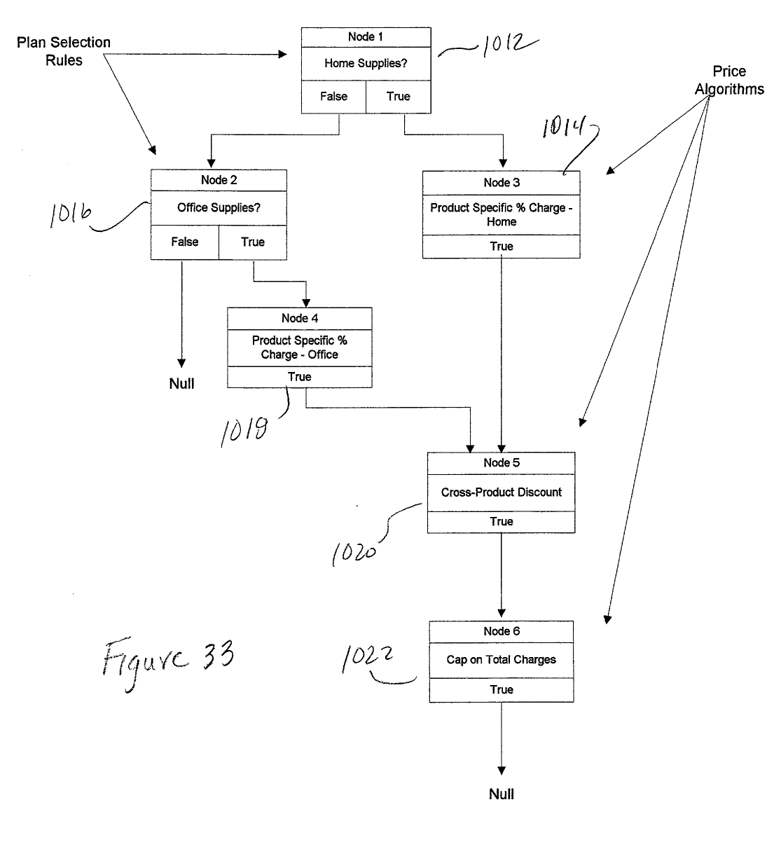

FIGS. 19-33 show a network or tree with a number of conditions and algorithms which supports the product specific percentage charge, a cross product discount and a cap on total fees of Price Plan 2. The tree includes conditional or tests 562 and 564 (see FIG. 19) with corresponding product specific charges 566 and 568, cross product summary charges 570 and 572 and summary caps 574 and 576 which are applied when the conditional are met. This network shows a differentiation by product, and cross product discounts and a cap that are applied to all types of products.

The decision network of FIG. 20 shows the home supplies condition having a test that tests whether the service (product) 612 is a home supply service is or has a value 614 of “Home Supplies” using an equal operator 616. This conditional only includes a single condition “a” (618) but several conditions can be combined using logic operators 620.

FIGS. 21, 22 and 23 show the summary taper percent charge calculation 632 with a sensitivity 642 for the home supplies with a band structure 652 similar to the calculation discussed previously where the bands are defined using the definitions 226 of FIG. 12.

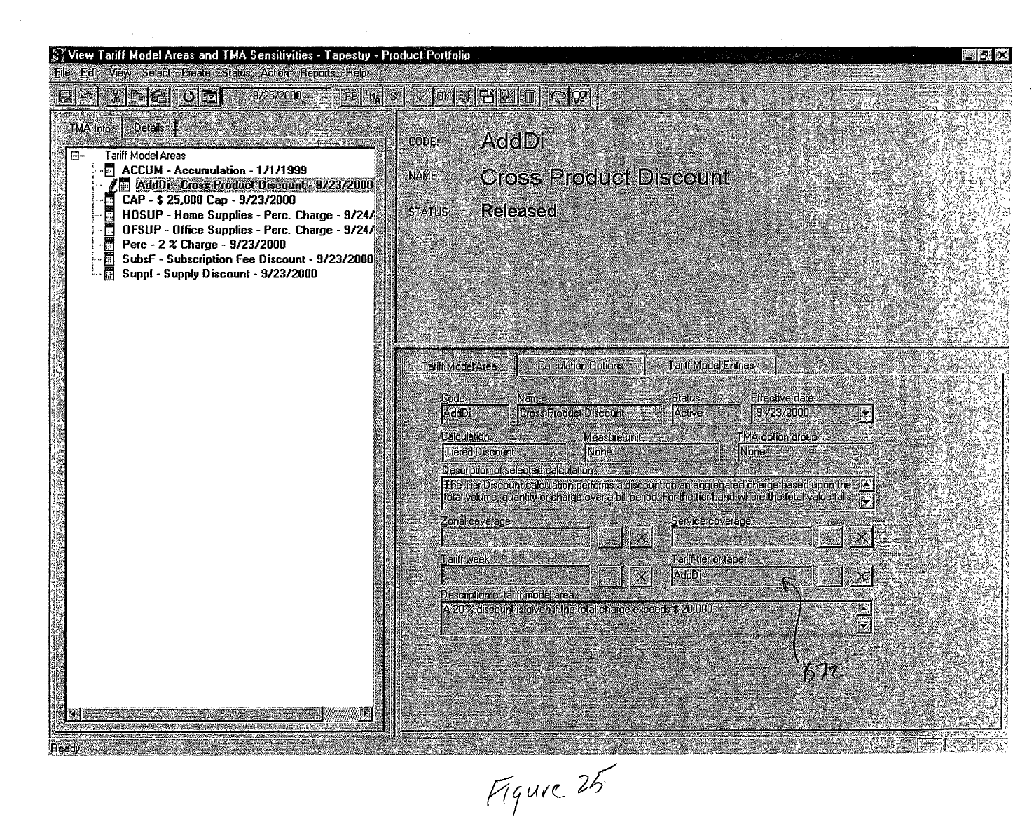

FIGS. 24, 25, 26 and 27 show the summary tiered discount calculation 662 with a taper sensitivity 672 having two tiers/bands 682 with corresponding percentage amounts 692.

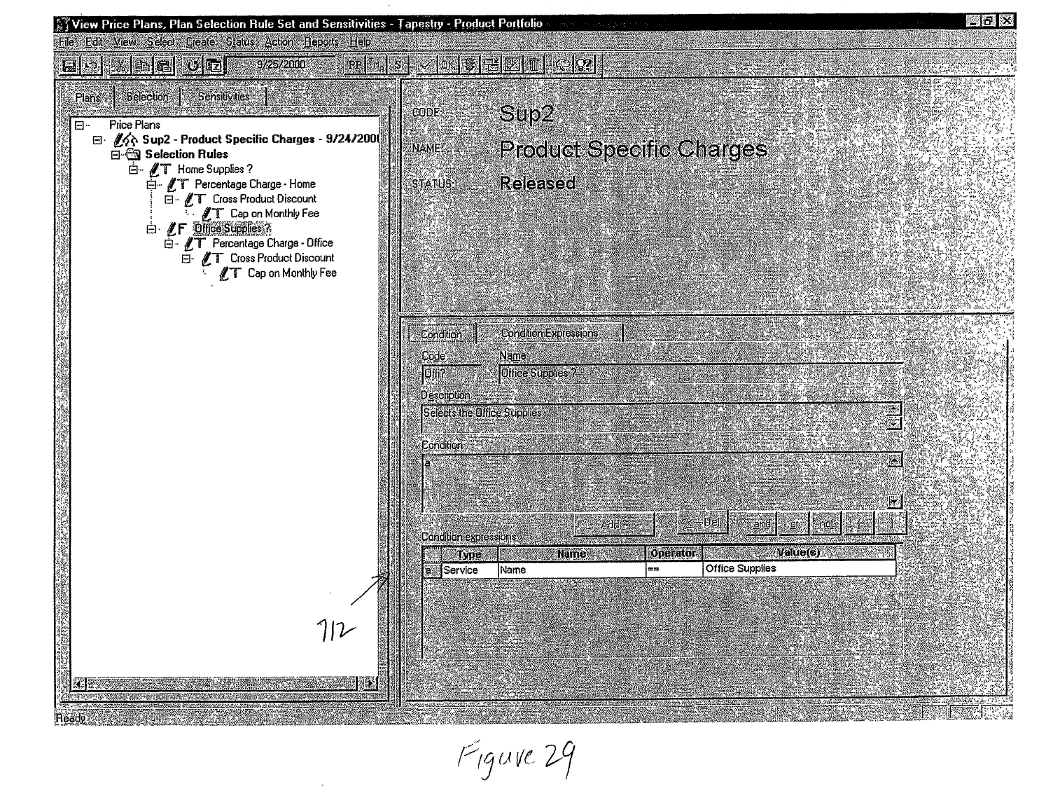

FIGS. 28 shows a cap calculation 702 similar to that previously discussed.

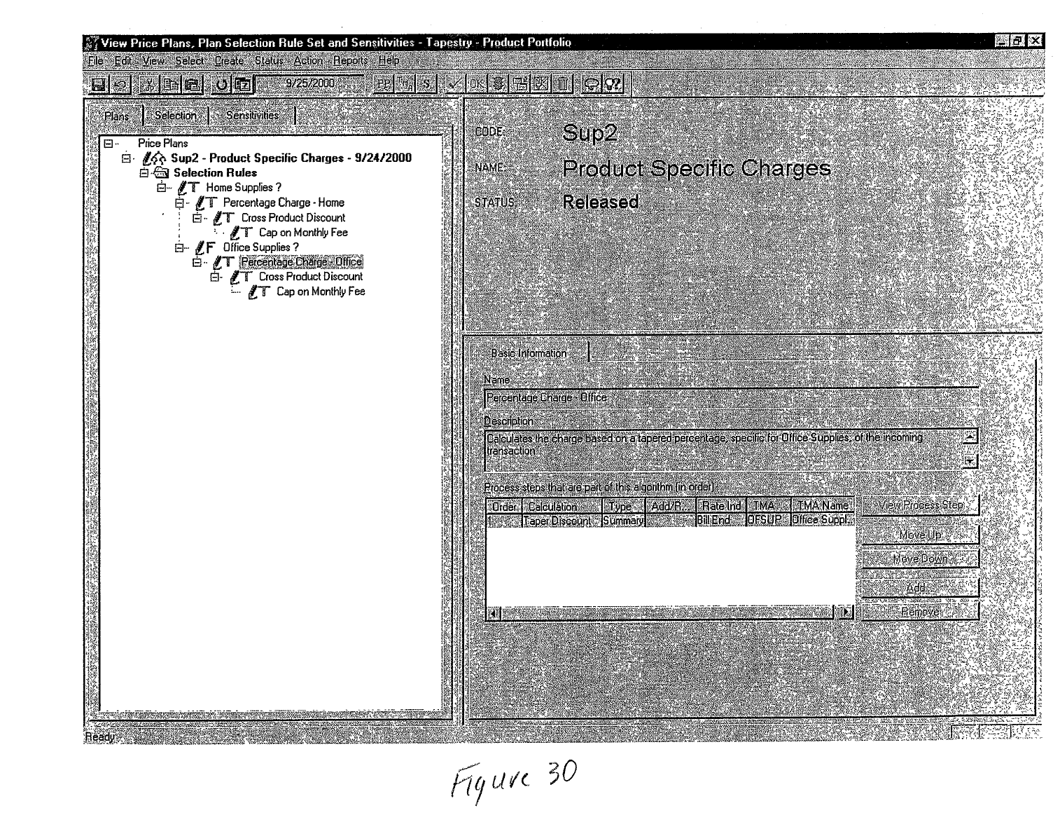

FIG. 29 shows the office supplies condition 712 which is similar to the condition previously discussed.

FIGS. 30, 31 and 32 show the taper charge discount calculation applied to office supplies and has a structure similar to that previously discussed.

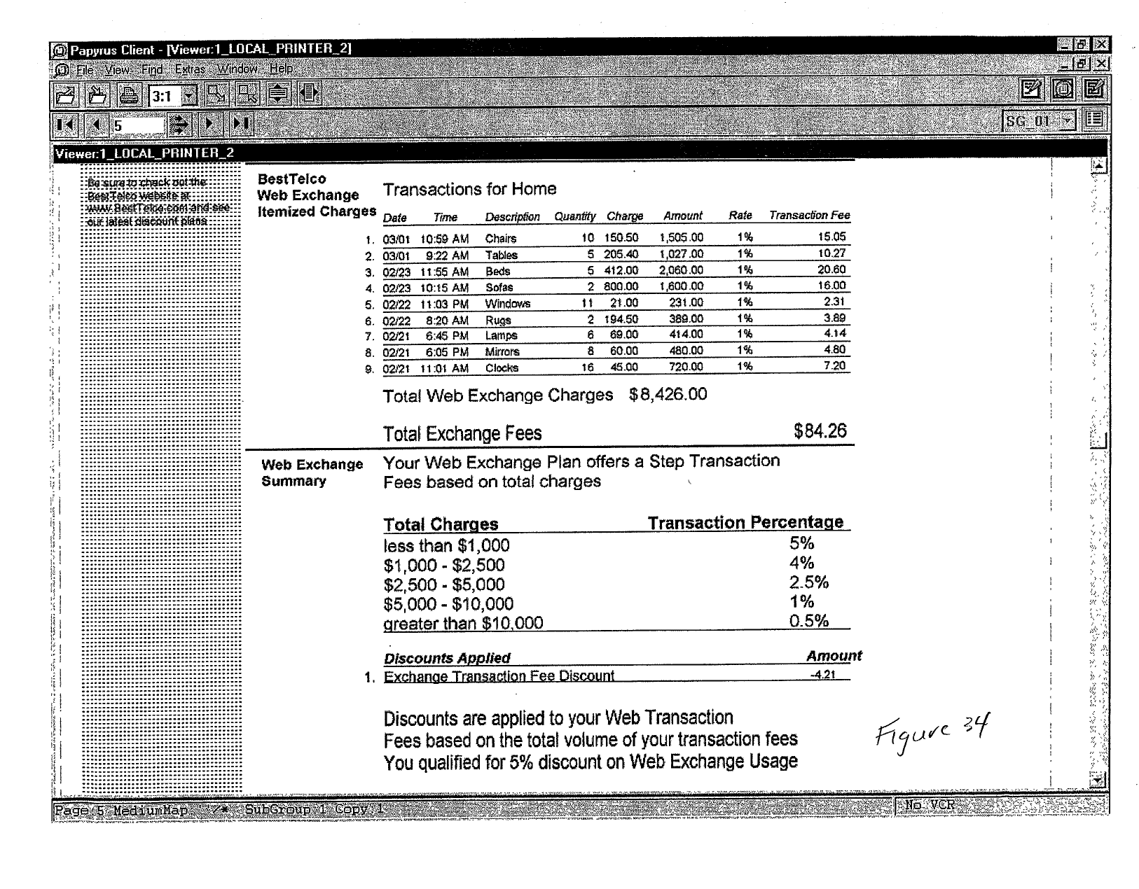

As depicted in FIG. 33, the decision network for the above discussed price plan includes six nodes. During processing of a transaction the system checks 1012 to see if the transaction is a home supply event. If so the system calculates 1014 the specific home supply charge. If not, the event is checked 1016 to determine whether the event is an office supply purchase transaction. If so, the specific office supply charge is calculated 1018. After the specific charges are completed, the system determines 1020 a cross product discount and then caps 1022 the charge if necessary.

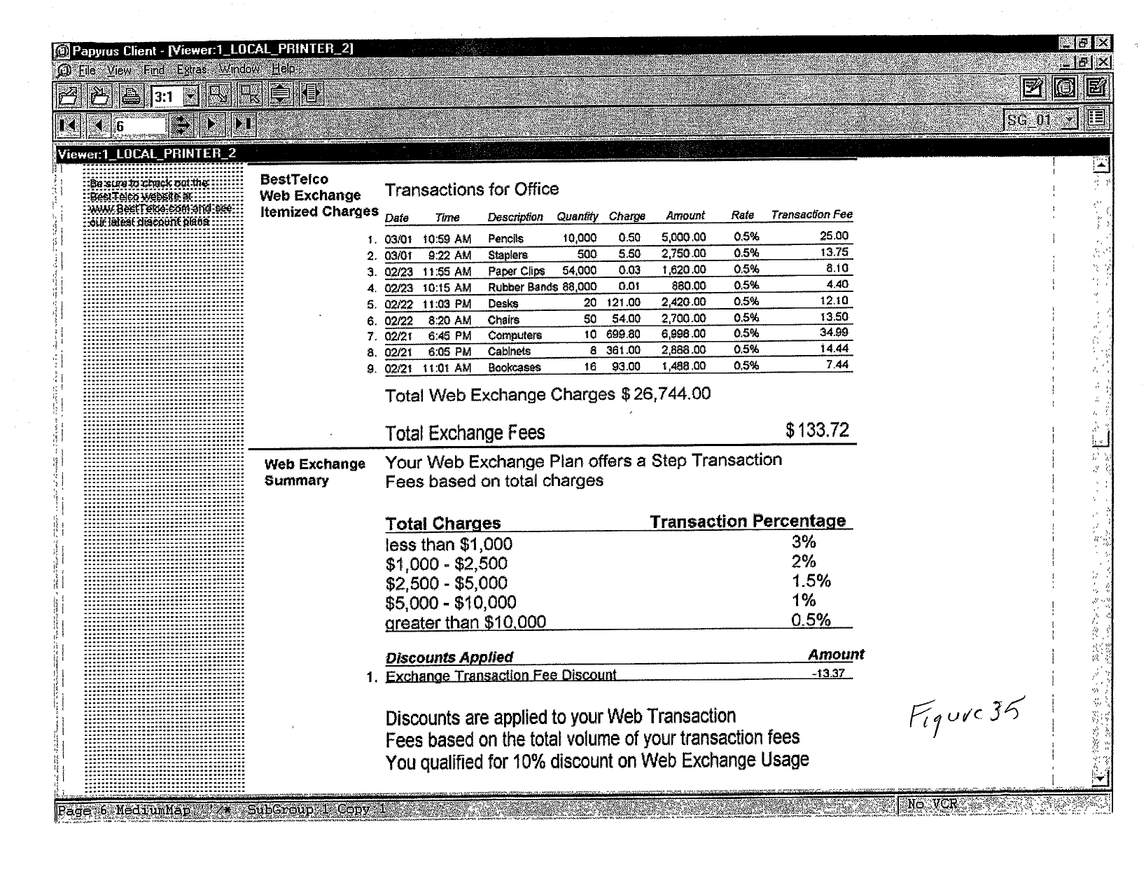

FIGS. 34 and 35 depict the charges for a set of transactions that include both office and home supplies using a price plan similar to that of FIGS. 19-33. No cross product discount is provided. These figures show a history of the transactions used in the calculations as well as the discounts being applied.

The third price plan (Price Plan 3—Scenario #4—Customer Specific Discount) applies an additional discount for special customers that are identified as belonging to the “Gold Association”. For these customers (buyers or suppliers), their transaction charges will be accumulated, and the level of charges will determine a discount that is applied towards their subscription fees (monthly charges) for using the Exchange.

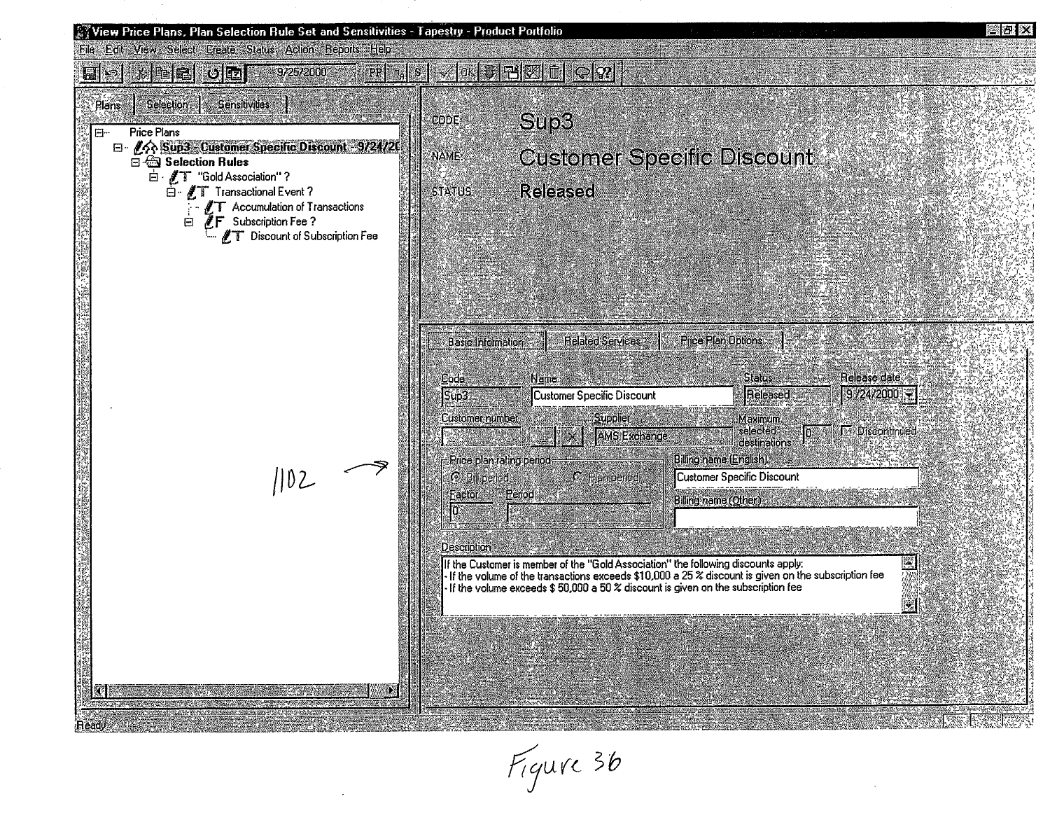

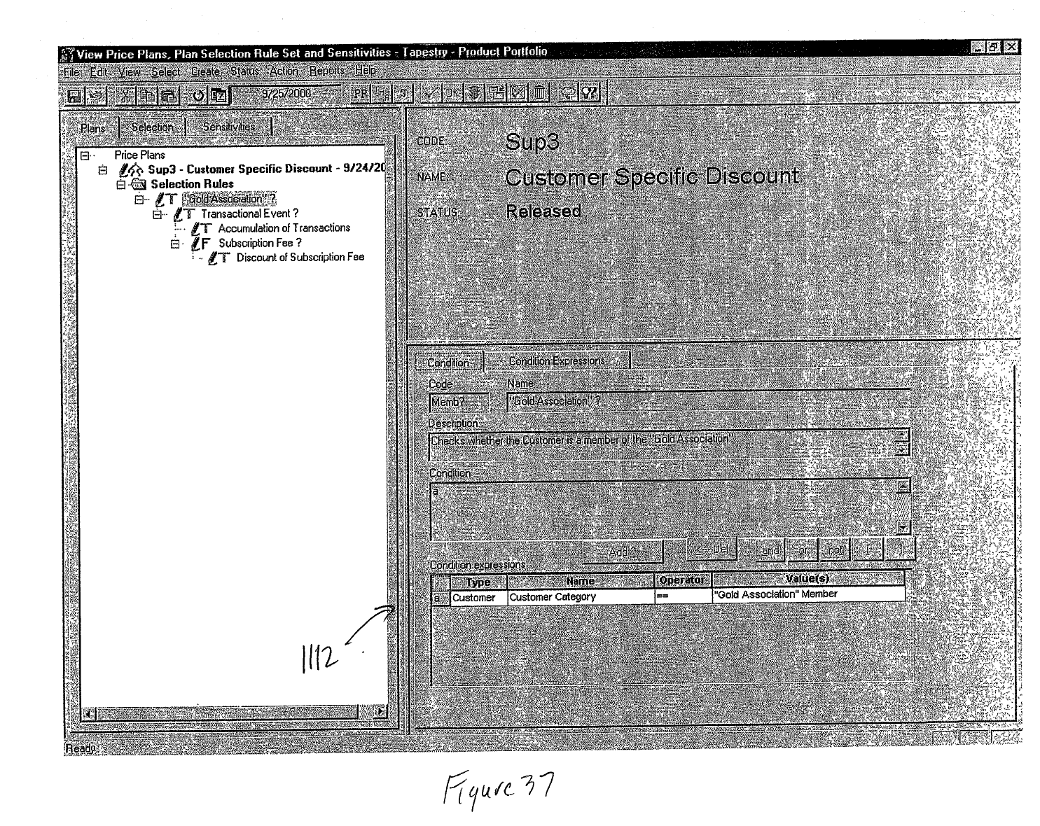

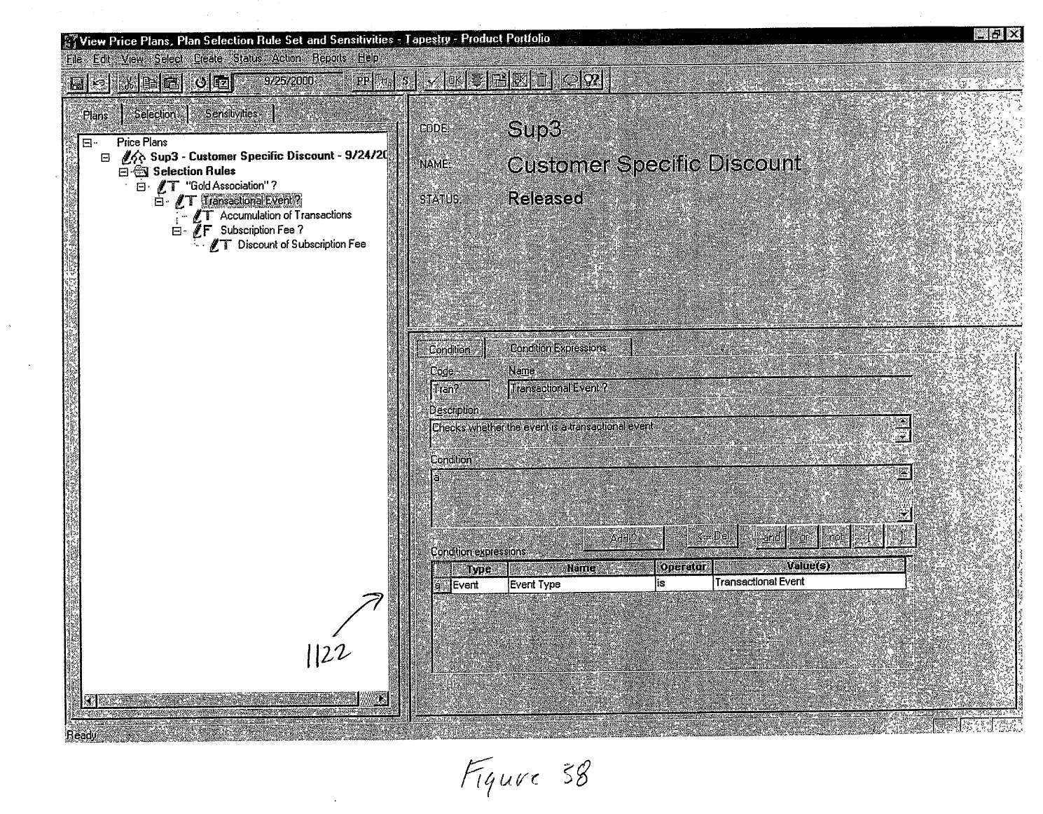

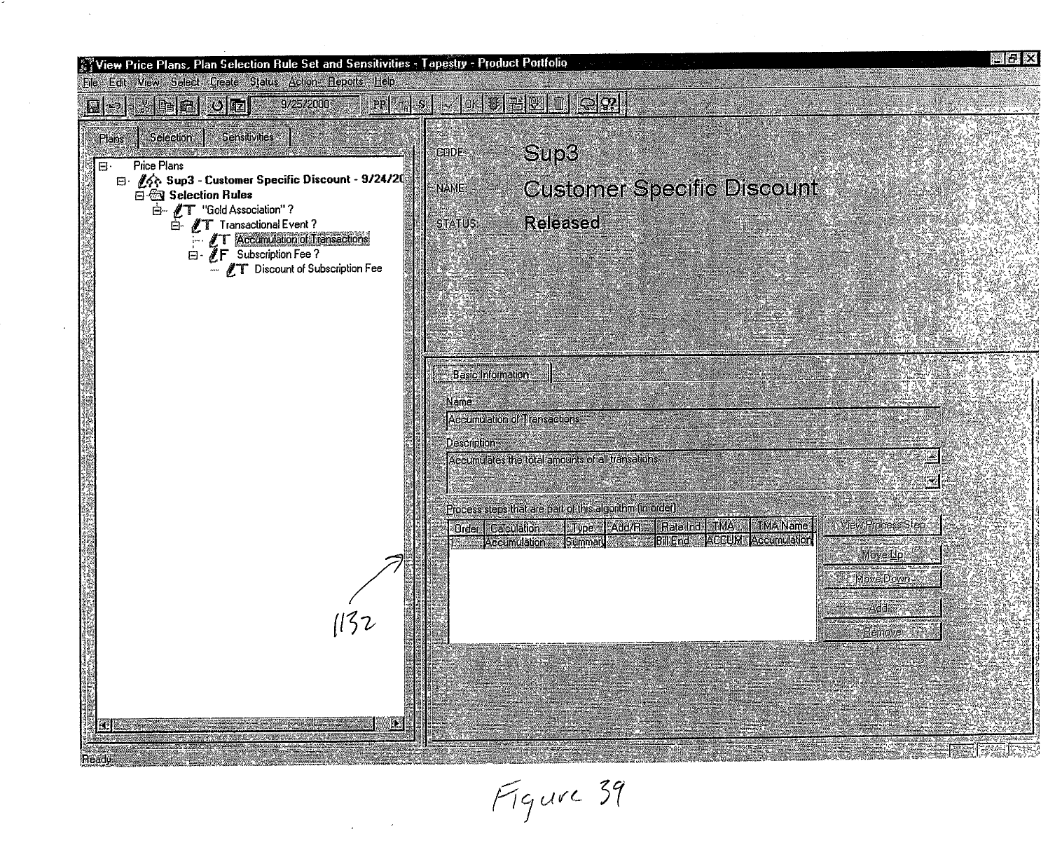

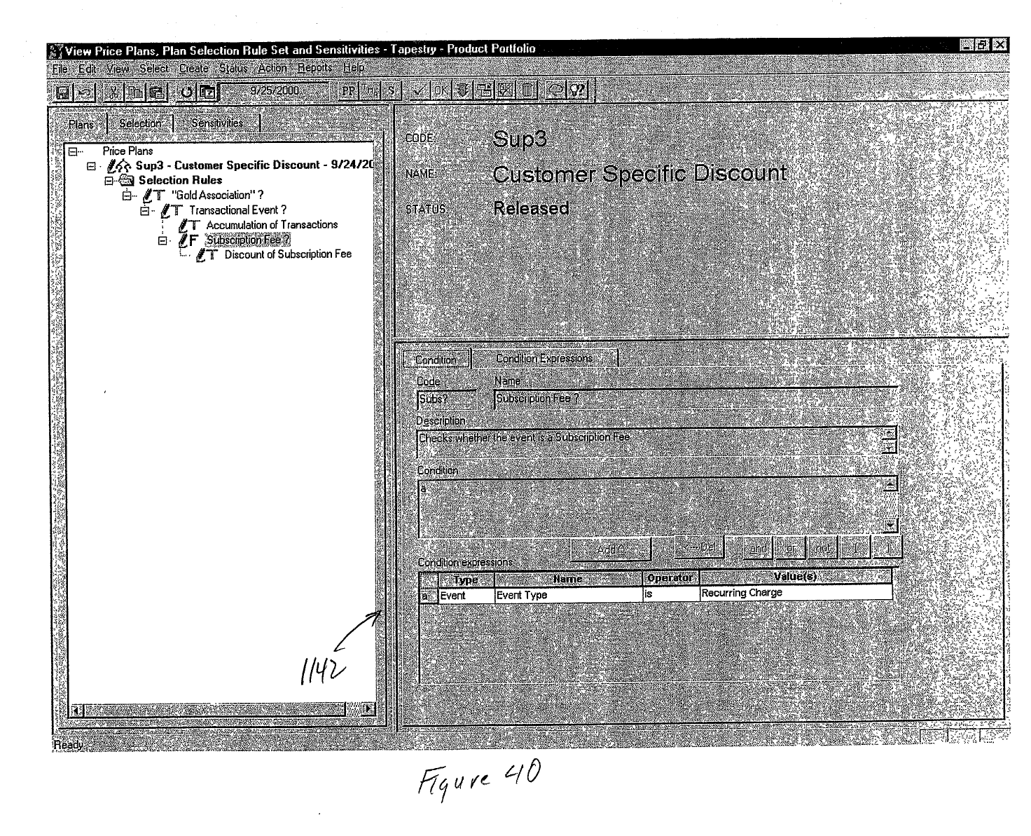

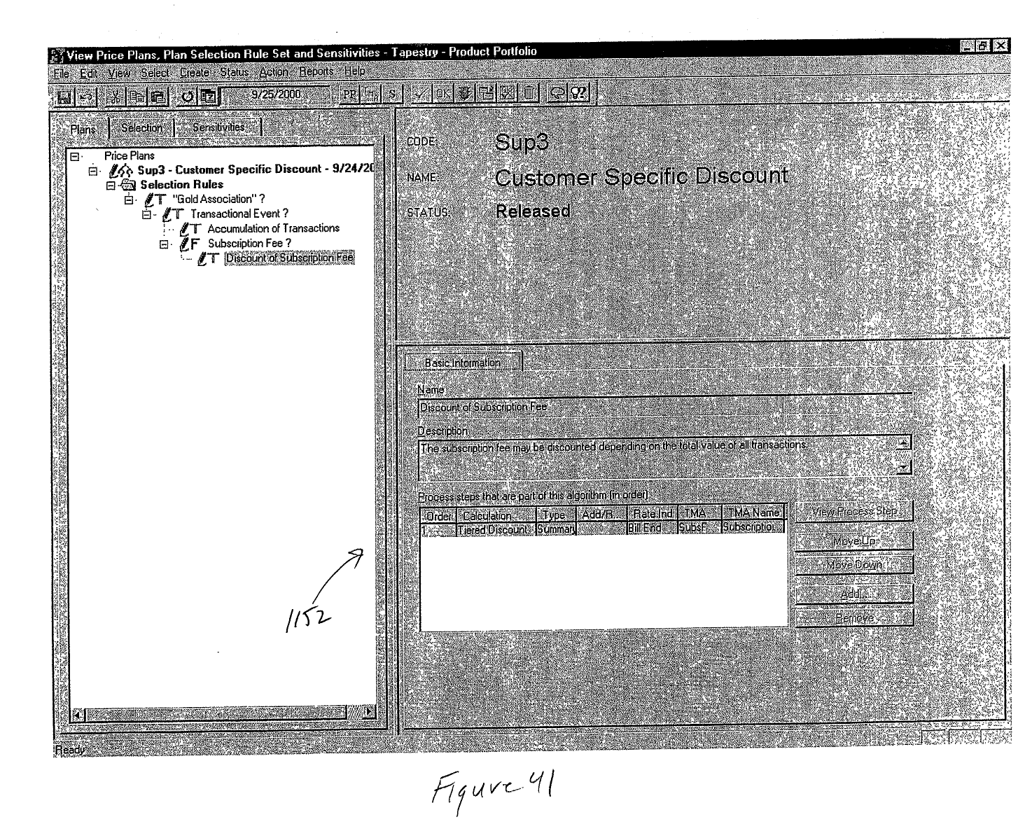

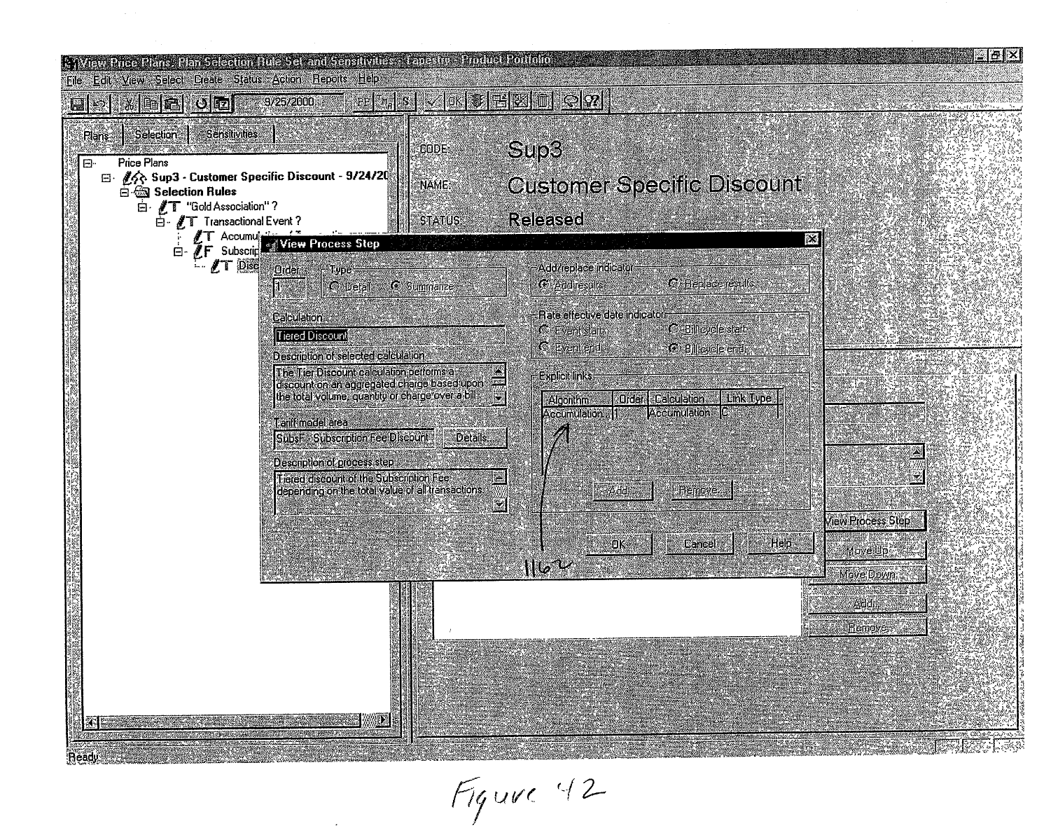

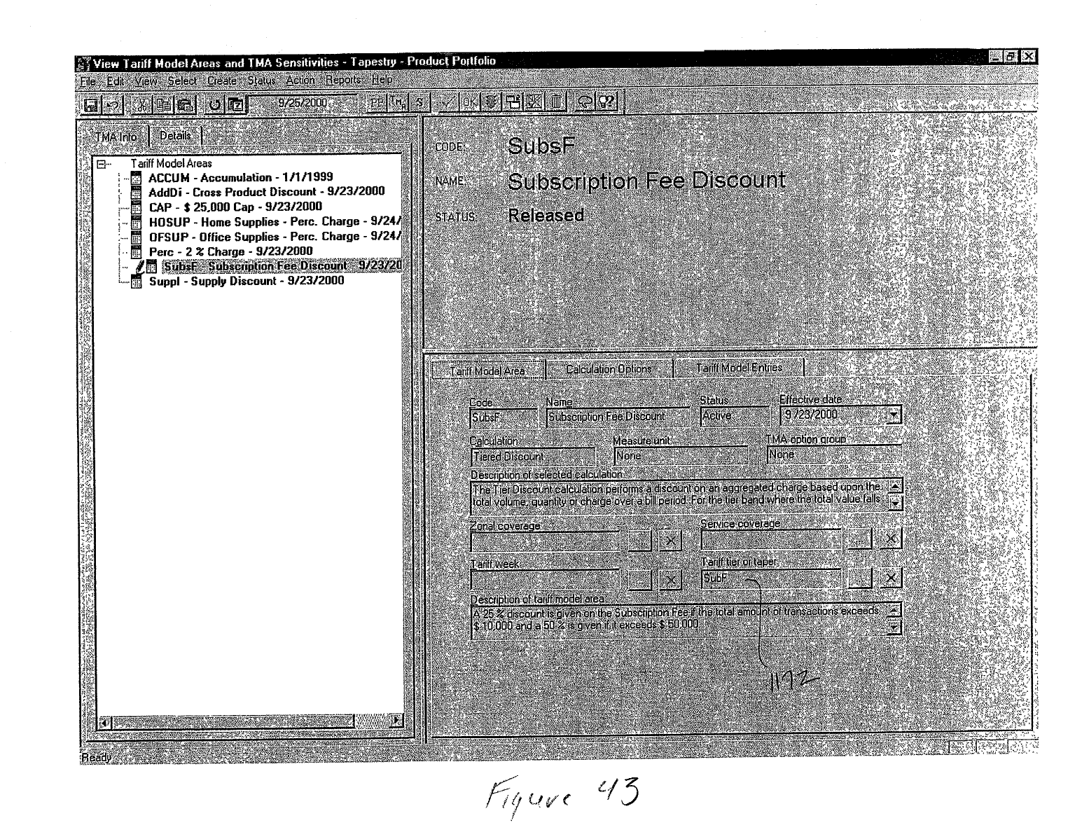

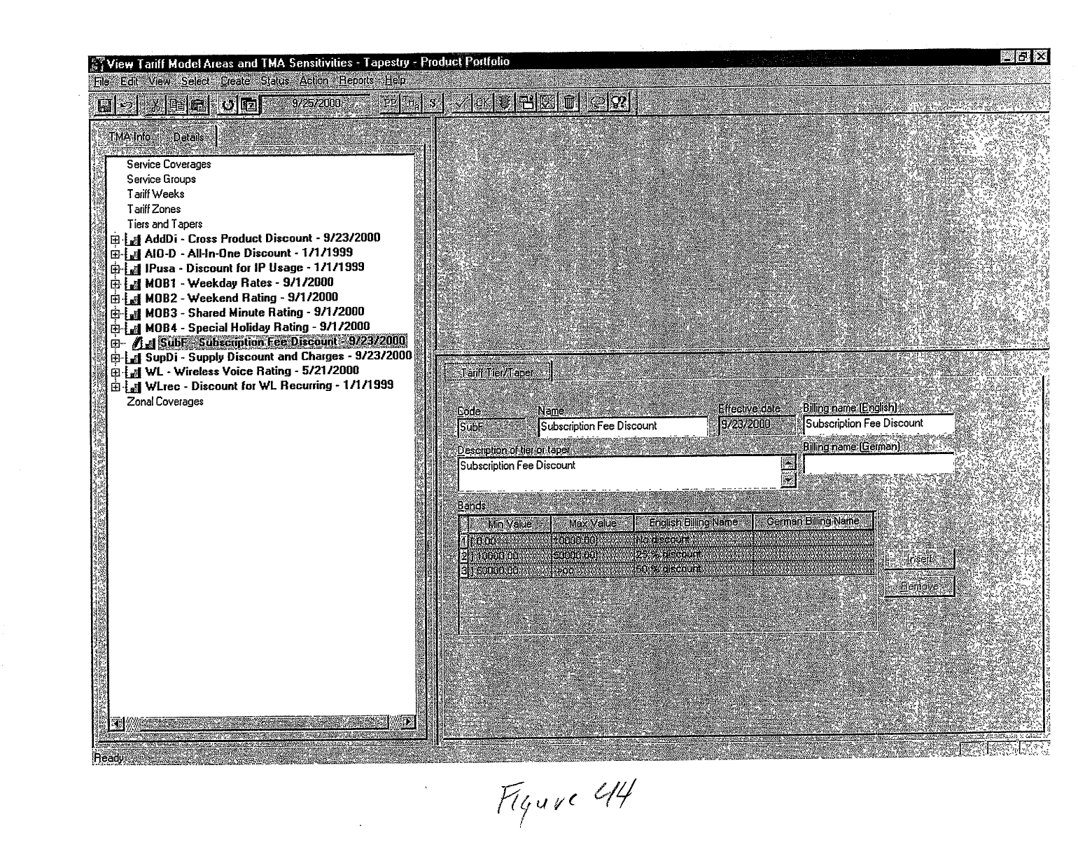

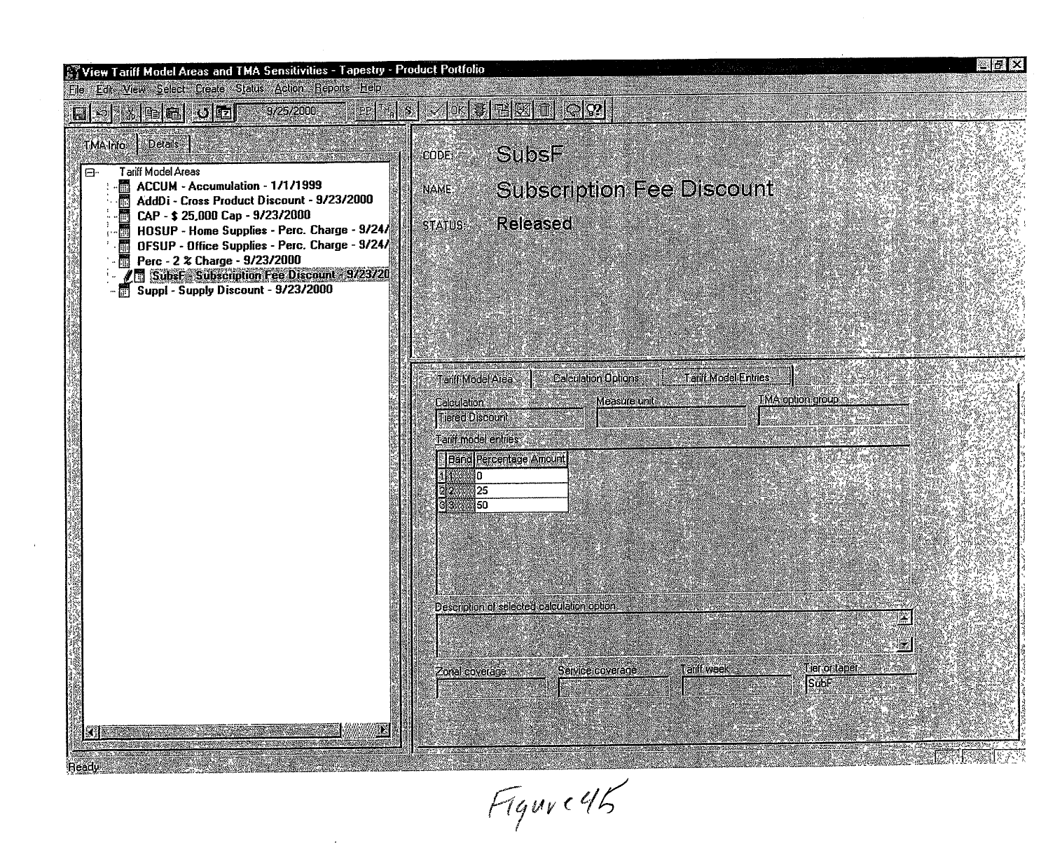

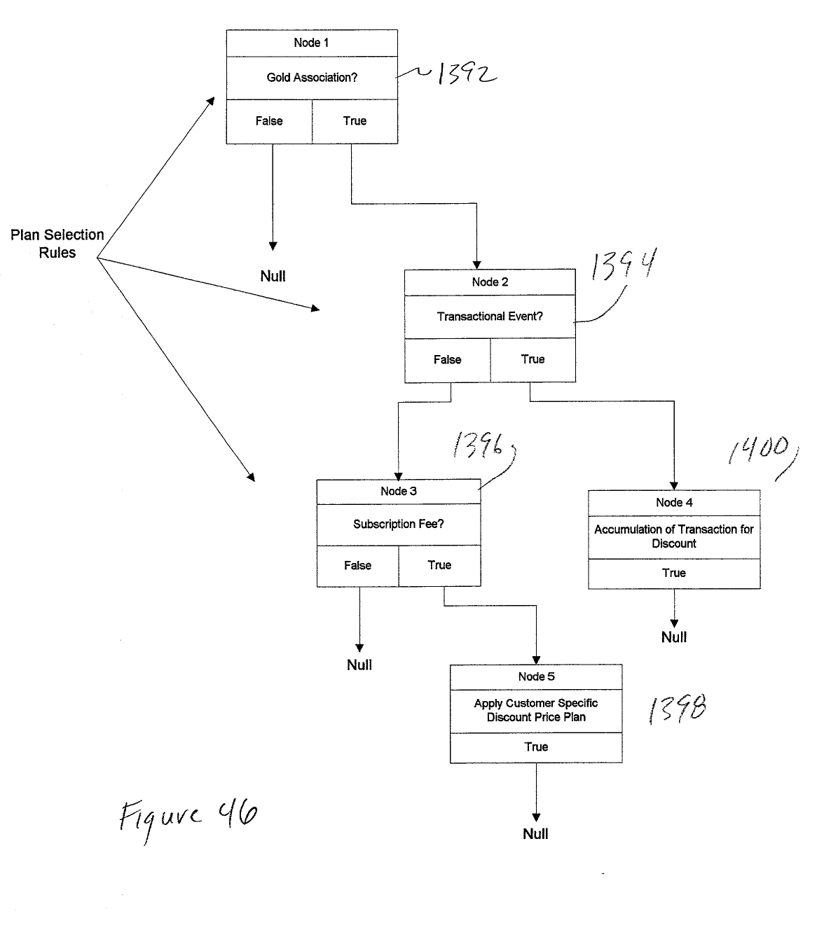

FIGS. 36-45 depict the details of the rules and calculations for this customer discount 1102. FIG. 37 shows a customer specific condition 1112 that uses information obtained through the Customer Center 20, FIG. 38 an event condition 1122 testing whether the event is a transnational event, FIG. 39 a summary accumulation calculation 1132 performed for the transnational event, FIG. 40 a recurring charge event condition 1142, FIG. 41 a tiered discount calculation 1152 performed for the recurring event based on the total value of the transactions, FIG. 42 shows the explicit link 1162 to the previously discussed and now reused contributing charge (“C”) accumulation algorithm, FIG. 43 the level of the contributing is necessary using a SubF 1172 taper, FIG. 44 the bands of the taper discount and FIG. 45 the percentage amounts for the bands.

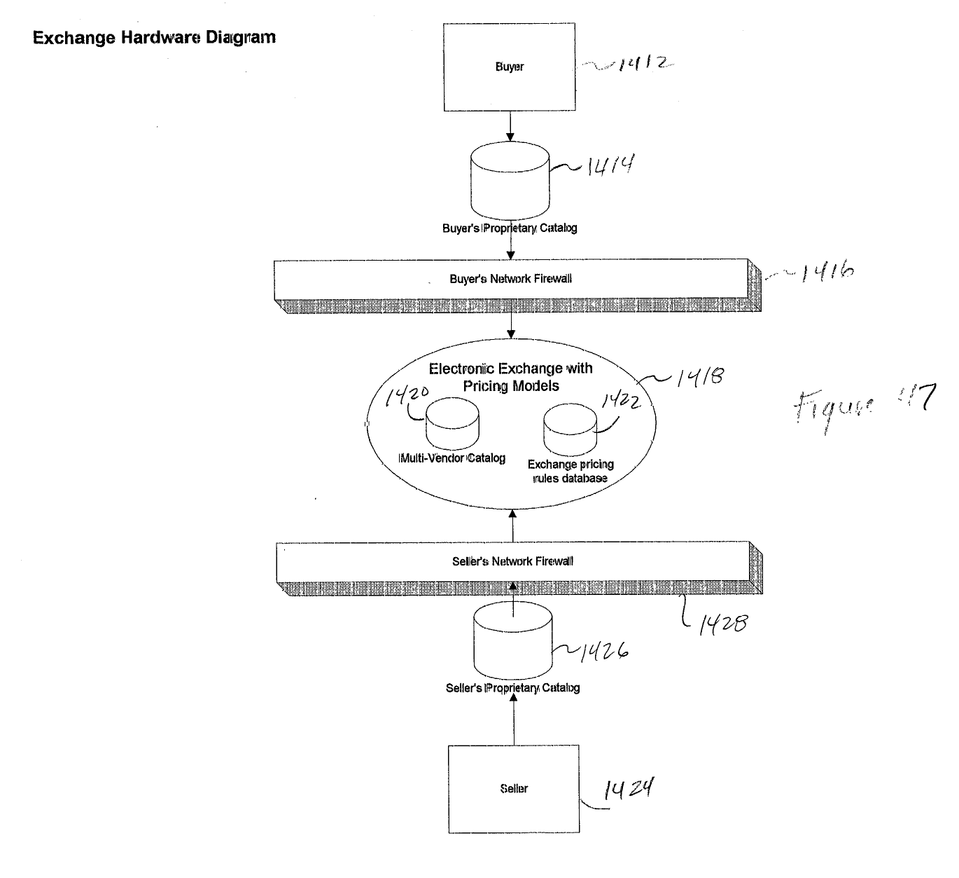

As depicted in FIG. 46, the decision network for the above discussed price plan includes five nodes. The system first determines 1392 whether the customer is a gold customer. If so, a determination 1394 is made as to whether the event is a transaction event. If not, the system tests 1396 to see if it is a subscription fee and applies 1398 the specific discount for the customer if so. If the event is a transaction event the event is accumulated 1400.

These above discussed price plans are three dissimilar models that illustrate the powerful ways that rules are used within the present invention to enable complex pricing of different electronic exchange events, navigating a user-defined decision network that can comprise rules for any attribute of any event created as part of a user's Exchange portal experience. No new code is necessary to interpret these rules, resolve the conditions within the network, calculate charges and discounts, and apply these to the relevant parties.

The processes of the applications and the TAPESTRY product enable the price plans as discussed herein to be implemented and to apply within a single “billing period”, e.g., monthly. The plans can also accumulate information across multiple periods, retaining “history” and applying pricing schemes across larger periods of time, such as yearly discounts based upon volumes over time.

The same concept of retaining event history, or “summaries” enables pricing of events based upon association with other events. For example, if a transaction is generated, and then later a second event corresponds to a cancellation of the transactions, these events can be correlated by the system, and priced according to any defined rules. For example, a cancellation might erase/reverse the transaction charge for the first event, it might be charged as a “normal” transaction event (thus both the transaction and the cancellation would be charged), the cancellation could be charged 50% of the transaction fee, etc.

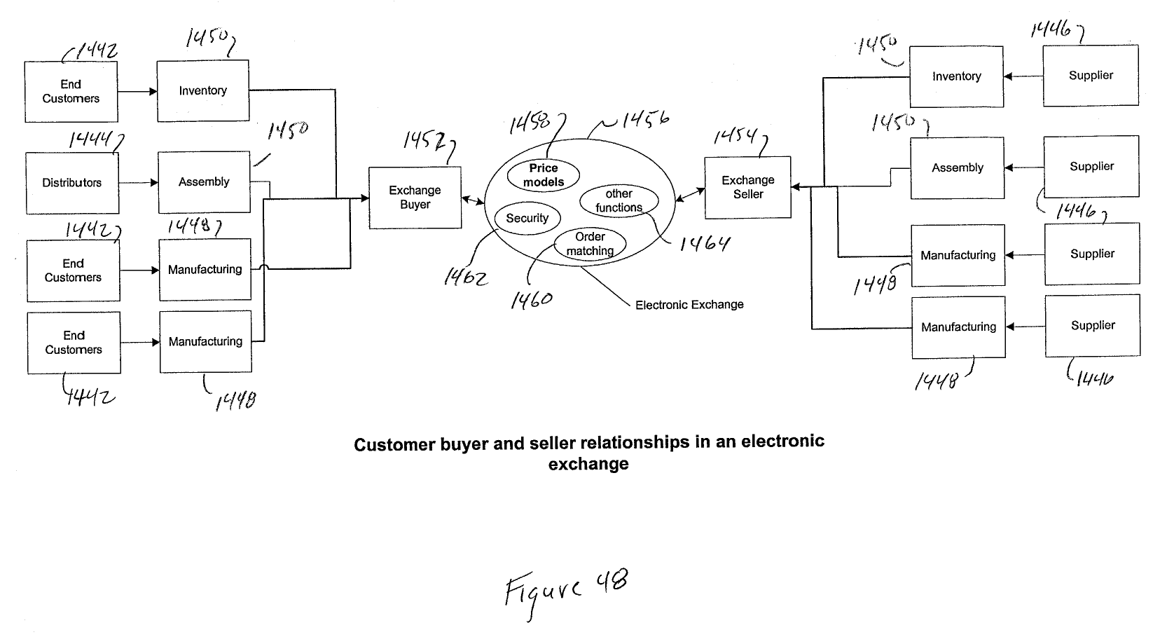

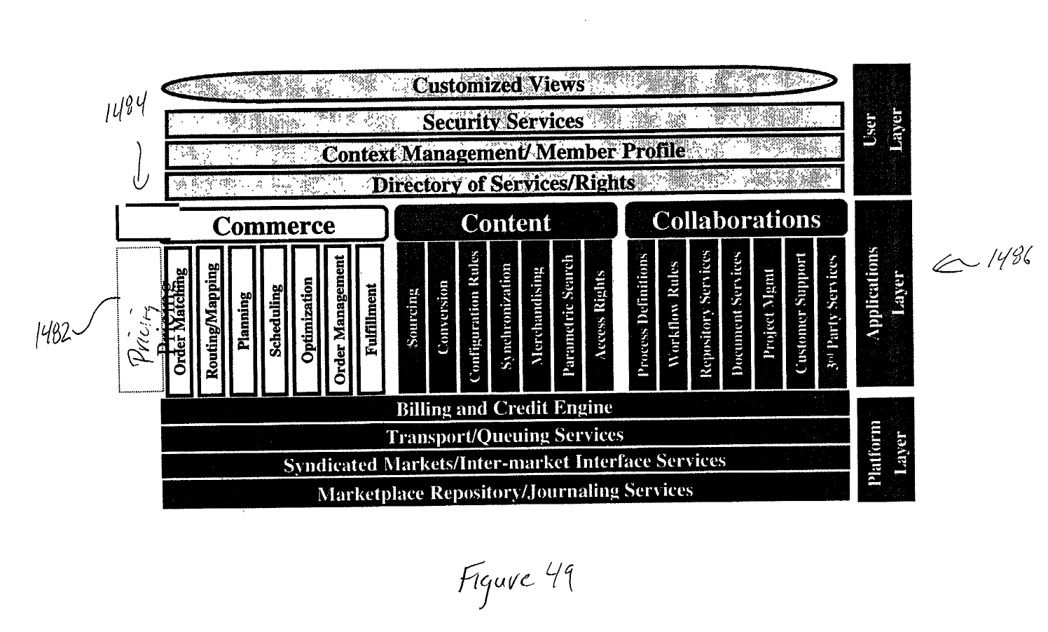

FIG. 47 depicts the relationship of a Buyer 1412 within a buyer's computer system having access to items for sale in a Multi-Vendor Catalog via a Buyer's Proprietary Catalog 1414 which presents catalog items in a format desired by the buyer. The Buyer 1412 can send purchase transactions through a Buyer Firewall 1416 to an Electronic Exchange 1418 which maintains a Multi-Vendor Catalog 1420 and executes Pricing Models/Plans 1422, such as previously discussed. The Electronic Exchange 1418 can be based on conventional electronic exchange systems and the pricing for the Exchange is provided by the pricing plan systems described herein. A Seller 1424 within the seller's computer system can provide sales entries into the Multi-Vendor Catalog 1420 through the Seller's Proprietary Catalog 1426 and the Seller Firewall 1428 where the Catalog 1426 presents catalog items in a format desired by the seller.

FIG. 49, showing Customer Buyer And Seller Relationships In An Electronic Exchange, depicts the complex relationships that can be maintained between End Customers 1442, Distributors 1444 and Suppliers 1446 though Manufacturing 1448 and Assembly 1450 systems which participate in an Exchange Buyer 1452 and an Exchange Seller 1454 and interact with the Electronic Exchange 1456. The Exchange 1456, as previously mentioned, maintains and executes Pricing Models 1458 according to the present invention, as well as performs the conventional exchange operations that include Order Matching 1460, transaction Security 1462 and Other Exchange Functions 1464.

FIG. 49 shows the pricing 1482 discussed herein integrated into the overall Electronic Exchange functions and particularly within the Commerce functions 1484 of the Application Layer 1486.

The system of the present invention also includes permanent or removable storage, such as magnetic and optical discs, RAM, ROM, etc. on which the process and data structures of the present invention can be stored and distributed. The processes can also be distributed via, for example, downloading over a network such as the Internet.

The present invention has been described with respect to the pricing of electronic exchange events based on a service or product exchanged between a buyer and a seller. Events that could be captured and affect pricing of goods and services can be things other than the goods and services exchanged. For example, review of an advertisement by a buyer is an event could result in a later applied discount, payment of exchange subscription fees could result in a discount, and a catalog query could provide a credit.

The present invention has been described as essentially being associated with an electronic exchange. The present invention can be embodied in a service that is provided to an exchange or it can be integrally incorporated into the exchange. The exchange and/or pricing can be a service.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
receiving an electronic entity event; and
dynamically and automatically pricing the event responsive to an electronic entity event pricing plan.

2. A method as recited in claim 1, wherein the event comprises one of a transaction with a good/service exchanged as part of the transaction, multiple transactions with goods/services, a product query, an advertisement review, transferring to another site, an exchange subscription fee, and a customer characteristic.

3. A method as recited in claim 1, wherein the pricing is responsive to relationships among buyers and sellers comprising negotiated customer specific rates and discounts.

4. A method as recited in claim 1, wherein the dynamic pricing plan uses a decision network having rule based functions.

5. A method as recited in claim 4, wherein said functions price the transaction across goods/services.

6. A method as recited in claim 4, wherein the rules based functions comprise conditional decisions.

7. A method as recited in claim 4, wherein the rules based functions comprise pricing calculation algorithms.

8. A method as recited in claim 7, wherein the algorithms comprise one of single unit, double unit, taper discount, tier, tier discount, percent, flat, charge, minimum, maximum, accumulation, threshold, multi-unit and taper charges.

9. A method as recited in claim 1, wherein said electronic event has a transaction price and a good/service price.

10. A method as recited in claim 1, wherein said electronic event comprises multiple transactions.

11. A method as recited in claim 1, wherein the pricing comprises detail and summary pricing.

12. A method associated with an electronic exchange which produces an electronic exchange event, said method comprising:
receiving the electronic exchange event; and
dynamically and automatically pricing the electronic exchange event responsive to an electronic exchange event pricing plan.

13. A method, comprising:
receiving an electronic exchange transaction request;
performing an electronic exchange function responsive to the electronic exchange transaction request; and
dynamically and automatically pricing an electronic exchange event responsive to an electronic exchange event pricing plan.

14. A method, comprising:
receiving electronic exchange events; and
dynamically and automatically pricing the electronic exchange events responsive to an electronic exchange event pricing plan having transaction pricing, cross product pricing, summary pricing and nontransaction pricing.

15. A method, comprising:
receiving electronic exchange transaction requests;
performing electronic exchange functions responsive to the electronic exchange request and where the function comprises transactions exchanging a goods/services having a goods/services prices; and
dynamically and automatically pricing the electronic exchange transactions with detail and summary pricing using an electronic exchange event pricing plan responsive to relationships among buyers and sellers and comprising negotiated customer specific rates and where the dynamic pricing plan uses a decision network having rule based functions pricing the transactions, pricing across the transactions, pricing across the goods/services, pricing with charge limitations and pricing non-transactions using conditional pricing decisions and pricing calculation algorithms comprising single unit, double unit, taper discount, tier, tier discount, percent, flat, charge, minimum, maximum, accumulation, threshold, multi-unit and taper charges.

16. A system, comprising:
an electronic exchange handling an electronic exchange event; and
a pricing mechanism dynamically pricing the electronic exchange event responsive to an electronic exchange event pricing plan.

17. A system as recited in claim 16, wherein said pricing mechanism comprises a code-based pricer and non-code based rules used by the pricer to price the event.

18. A computer readable storage controlling a computer by dynamically and automatically pricing the electronic exchange event responsive to an electronic exchange event pricing plan.
